(19) United States
(12) Patent Application Publication
(10) Pub. No.: US 2018/0173033 A1
(43) Pub. Date: Jun. 21, 2018

(54) METHOD OF PRODUCING DISPLAY DEVICE, AND DISPLAY DEVICE

(71) Applicant: SHARP KABUSHIKI KAISHA, Sakai City, Osaka (JP)

(72) Inventor: KATSUYUKI SUGA, Sakai City (JP)

(73) Assignee: SHARP KABUSHIKI KAISHA, Sakai City, Osaka (JP)

(21) Appl. No.: 15/736,742

(22) PCT Filed: Jun. 9, 2016
(86) PCT No.: PCT/JP2016/067172

§ 371 Date: Dec. 14, 2017

(30) Foreign Application Priority Data
Jun. 16, 2015 (JP) 2015-121199

(51) Int. Cl. G02F 1/1339; G02F 1/1362; G02F 1/1333; G02F 1/1345

(52) U.S. Cl. CPC G02F 1/1339; G02F 1/136286; G02F 1/133514; G02F 1/13452; G02F 1/133345

(57) ABSTRACT

A method includes a first resin film forming process of forming a first resin film on one section of a first substrate, a metal line forming process of forming metal lines continuously on another section of the first substrate and the first resin film and forming an insulator film on the metal lines, a pattern forming process of forming thin film patterns on the other section, a bonding process of disposing sealant on the first substrate and bonding the first and second substrates opposite each other, a second substrate removing process of removing a section of the second substrate outside the sealant, a second resin film forming process of forming a second resin film on the first resin film outside the sealant, and a first substrate removing process of separating and removing at least a section of the first substrate outside the sealant from the first resin film.

### TECHNICAL FIELD

The present invention relates to a method of producing a display device, and a display device.

### BACKGROUND ART

In a display panel such as a liquid crystal panel included in a display device, a technology for connecting a flexible circuit board having flexibility to an outer frame portion of a substrate included in the display panel has been known. The flexible circuit board is connected to the outer frame portion to supply driving signals or power to the display panel. Generally, in a method of producing a display device, after a pair of substrates of the display panel are bonded to each other with a sealant, such a flexible circuit board disposed on and connected to an outer frame portion of one of the substrates via an anisotropic conductive film (ACF). A liquid crystal display device including a flexible circuit board that is connected to the substrate of the display panel via the ACF is disclosed in Patent Document 1.

### RELATED ART DOCUMENT

### Patent Document

Patent Document 1: Unexamined Japanese Patent Application Publication No. 2009-128779

### Problem to be Solved by the Invention

However, in the liquid crystal display device disclosed in Patent Document 1, the liquid crystal panel includes a silicon substrate and a transparent substrate that are bonded to each other with a sealant, and a connection area (a mounting area) for connecting the flexible circuit board is provided on a part of the silicon substrate and outside the sealant so as to be projected from the transparent substrate. The flexible board is connected to the silicon substrate with thermal press-bonding and therefore, the connection area of the flexible circuit board necessarily has a width of approximately 1 mm to 2 mm. Therefore, in a configuration that the silicon substrate has the mounting area for the flexible circuit board outside the sealant, the frame width of the display device is increased by the mounting area and a narrow frame of the display device is less likely to be achieved.

### DISCLOSURE OF THE PRESENT INVENTION

The present invention was made in view of the above circumstances. An object is to achieve a narrow frame in a display device.

### Means for Solving the Problem

A technology described in this specification is related to a method of producing a display device including a first resin film forming process of forming a first resin film having flexibility on one section of a first substrate, a metal line forming process of forming metal lines continuously on another section of the first substrate and on the first resin film and forming an insulator film on the metal lines, a pattern forming process of forming thin film patterns on the other section of the first substrate, a bonding process of disposing sealant on the first substrate to surround the thin film patterns and bonding the first substrate and a second substrate opposite each other with the sealant after the resin film forming process, the metal line forming process, and the pattern forming process, a second substrate removing process of removing a section of the second substrate outside the sealant after the bonding process, a second resin film forming process of forming a second resin film on the first resin film outside the sealant after the second substrate removing process, and a first substrate removing process of separating and removing at least a section of the first substrate outside the sealant from the first resin film after the bonding process. The term “forming metal lines continuously” in this specification means lines that are continuously formed of only metal lines and does not only mean lines formed of a single metal film but also mean lines formed of multiple metal films.

In the above method of producing a display device, the thin film patterns are formed on the other section of the first substrate in the pattern forming process. If the thin film transistors are formed of the thin film patterns, sections of the metal lines formed on the other section of the first substrate are configured as the gate electrodes of the thin film transistors.

In the metal line forming process, the metal lines are formed to continue from the other section of the first substrate to the first resin film, and the insulator film is formed on the metal lines. Therefore, the first resin film formed in the section of the first substrate in the first resin film forming process and the metal lines and the insulator film formed on the first resin film are configured as the flexible circuit board for transmitting signals for driving a produced display device. According to the method, the flexible circuit board is connected onto the first substrate without press-bonding the first end of the flexible circuit board onto the first substrate.

The bonding process is performed after the above-described processes. Ina configuration that the first end of the flexible circuit board is the connecting section connected to the first substrate, the sealant can be applied such that the connecting section of the flexible circuit board is located inside the sealant of at a position near the sealant (including a position overlapping the sealant in the thickness direction of the first substrate) in the bonding process. In the second substrate removing process and the first substrate removing process, large sections of the first substrate and the second substrate outside the sealant can be removed without having need for maintaining mounting areas for mounting the flexible circuit board outside the sealant as in the known technology. The second resin film is formed on the first resin film that is outside the sealant in the second resin film forming process such that strength of the flexible circuit board outside the sealant is reinforced by the second resin film. As a result, in comparison to the known liquid crystal display device including the mounting area for mounting the flexible circuit board outside the sealant, the display device achieving a reduced frame width can be produced.

In the above method of producing a display device, in the first resin film forming process, the first resin film, the metal lines, and the insulator film may be formed such that a total of thicknesses of the first resin film, the metal lines, and the insulator film is smaller than a distance between the first substrate and the second substrate that are bonded opposite each other in the bonding process, and in the second resin film forming process, the second resin film may be formed to have a thickness greater than a total of thicknesses of the first resin film, the metal lines, and the insulator film.

According to such a method, a specific reference of a total of the thicknesses of the first resin film, the metal lines, and the insulator film can be provided such that the first resin film, the metal lines, and the insulator film of the flexible circuit board are formed between the first substrate and the second substrate that are bonded opposite each other. If a total of the thicknesses of the first resin film, the metal lines, and the insulator film is smaller than a distance between the first substrate and the second substrate, strength of the flexible circuit board may be lowered. In the above method, the second resin film has a thickness greater than a total of the thicknesses of the first resin film, the metal lines, and the insulator film and therefore, the strength of the first resin film can be effectively reinforced by the second resin film and the strength of the flexible circuit board is less likely to be lowered.

In the method of producing a display device, in the first resin film forming process and the metal line forming process, the first resin film, the metal lines, and the insulator film may be formed such that a total of thicknesses of the first resin film, the metal lines, and the insulator film is smaller than a thickness of the thin film patterns formed in the pattern forming process.

If the display device produced with the above method is a liquid crystal display device, the sealant generally includes a spacer having a size corresponding to the thickness of the liquid crystal layer that is a space from an upper surface of the thin film patterns to the second substrate. If a total of the thicknesses of the first resin film of the flexible circuit board, the metal lines, and the insulator film is greater than the thickness of the thin film patterns, the flexible circuit board may push up the second substrate via the spacer in the section of the flexible circuit board overlapping the sealant, and a distance between the first substrate and the second substrate may not be maintained proper.

In the metal line forming process, if the metal line patterns that are continuously formed on the other section of the first substrate and the first resin film with the photolithography method, a photoresist film is required to be formed on the metal film of the metal lines so as to extend over a difference in level between the other section of the first substrate and the first resin film. Therefore, if the thickness of the first resin film is great and accordingly the thickness of the flexible circuit board is great, a great difference in level may be created between the other section of the first substrate and the first resin film. If such great difference is created, a photoresist film formed at the boundary between the first substrate and the first resin film is thicker than the photoresist film formed on other sections. An unnecessary photoresist film may remain at the boundary. As a result, an etching failure of the metal film may be caused and short-circuit may occur between the metal lines at the section where the photoresist film remains.

According to the above method, the first resin film, the metal lines, and the insulator film are formed such that a total of the thicknesses of the first resin film, the metal lines, and the insulator film is smaller than a thickness of the thin film patterns. Therefore, problems that a proper distance cannot be maintained between the first substrate and the second substrate or a short-circuit occurs between the metal lines are less likely to be caused.

The method of producing a display device may further include a light applying process of applying light on a boundary between the section of the first substrate that is to be removed in the first substrate removing process and the resin film before the first substrate removing process.

According to the above method, light is applied to a boundary between a section of the first substrate to be removed in the first substrate removing process and the first resin film to form a weak layer at the boundary by light energy. Therefore, the section of the first substrate is likely to be removed from the resin film in the first substrate removing process.

In the method of producing a display device, in the first resin forming process, the first resin film that is mainly made of polyimide may be used.

In forming the thin film patterns on the first substrate in the pattern forming process, the first substrate may be subjected to heat treatment at high temperature. If the first resin film forming process is performed prior to the pattern forming process and the resin for forming the first resin film has low heat resistance properties, the first resin film may be adversely affected in the pattern forming process. In the above method, the first resin film mainly containing polyimide having higher heat resistance is used and the first resin film is less likely to be adversely affected in the pattern forming process.

In the method of producing a display device, in the first resin film forming process, the first resin film may be formed on the first substrate while providing an area for mounting a driver component for driving the display device on an opposite side from an area for forming the thin film patterns with sandwiching the first resin film therebetween, in the first substrate removing process, at least a part of a section of the first substrate except for the area that is provided in the first resin film forming process may be removed, and the method may further include a mounting process of mounting the driver component on the area on the first substrate provided in the first resin film forming process after the second substrate removing process.

According to such a method, a part of the section of the first substrate except for the section for mounting a driver component that is provided in the first resin forming process is removed in the first substrate removing process. The driver component is mounted on the section of the first substrate such that the first resin film positioned between the sealant and the driver component after the first substrate removing process can be warped and folded. Therefore, the driver component can be mounted by the COG mounting method on the first substrate without having need for providing the mounting area for the driver component outside the sealant. The display device having a narrower frame can be produced.

In the method of producing a display device, in the first resin film forming process, the first resin film including a metal film may be formed near a boundary with the first substrate.

According to such a configuration, in the first substrate removing process, a laser beam may be applied to the first substrate from an opposite side from a side where the first resin film is formed, for example, to remove the first substrate.

In such a case, the laser beam is applied to the metal film and the laser beam is not directly applied to the polyimide film. Therefore, the polyimide film is less likely to be damaged or broken by the laser beam.

Another technology described in this specification is related to a display device including a display panel including substrates in a pair that are bonded with sealant, the display panel performing displaying, a flexible circuit board having flexibility and including thereon metal lines through which signals for driving the display panel are transmitted and an insulator film covering the metal lines, the flexible circuit board having a first end that is connected to one of the substrates and having a section that is between the substrates and overlaps the sealant in a thickness direction of the substrates, and the flexible circuit board being formed of a first resin film, and a reinforcing resin film for reinforcing the flexible circuit board, the reinforcing resin film being formed of a second resin film and disposed on the first resin film and outside the substrates and having a thickness greater than that of the first resin film.

In the above display device, a section of the flexible circuit board having metal lines through which signals for driving the display panel are transmitted thereon is disposed between the substrates in a pair of the display panel and to overlap the sealant. Therefore, flexible circuit board is connected to the display panel at a position overlapping the sealant or inside the sealant. It is not necessary to provide a mounting area for mounting the flexible circuit board outside the sealant, and compared to the known display device including the mounting area for the flexible circuit board outside the sealant, the display device achieves a narrower frame.

In the above display device, the flexible circuit board is reinforced by the reinforcing resin film disposed outside the substrates. Therefore, the flexible circuit board can have a thickness such that a section of the flexible circuit board can be disposed between the substrates and strength of the flexible circuit board is less likely to be lowered. In this specification, the flexible circuit board is a board different from the boards included in the display panel.

In the display device, one of the substrates may include thin film patterns thereon, the sealant may be disposed to surround the thin film patterns, and the metal lines may be formed of a single metal film and a section of the metal lines may form a section of the thin film patterns and the metal lines may extend continuously from the thin film patterns to outside of the sealant.

The above configuration is achieved by performing a process of forming the thin film patterns on the substrate and a process of forming the metal lines are in the same process of the producing process of the display device, for example. The production process is shortened. With the above configuration, a narrower frame is achieved in a display device while shortening the production process.

In the above display device, the display panel may include a display area and a non-display area within a panel surface area, the display area displaying images and the non-display area displaying no images, and the flexible circuit board may be disposed such that the section thereof between the substrates is disposed only in a position overlapping the non-display area in the thickness direction of the substrates.

If material of the flexible circuit board is opaque and a section of the flexible circuit board overlaps the display area of the liquid crystal panel, a display failure may occur in the overlapping area. Even if material of the flexible circuit board is transparent, display quality may be deteriorated in the overlapping area according to the optical properties of the material. According to the above configuration, the flexible circuit board overlaps only the non-display area and therefore, such a display failure or degradation in display quality is less likely to occur.

In the above display device, the display panel may have a rectangular shape in a plan view, and the flexible circuit board may be disposed on one side of the display panel and a dummy board may be disposed on at least one of other sides of the display panel such that a part of the dummy board is between the substrates and overlaps the sealant in the thickness direction of the substrates, and the dummy board may be made of material same as the flexible circuit board and may have a thickness same as the flexible circuit board.

If the flexible circuit board is disposed on only one-side section of the display panel of a rectangular plan view shape, pressure may not be evenly applied within a panel surface area of the display panel in bonding the substrates during the process of producing the display panel. A distance control between the substrates may be difficult. According to the above configuration, the dummy board is disposed on at least one of other sides of the display panel in the same way as the flexible circuit board. The dummy board is made of the same material and has the same thickness as the flexible circuit board. Therefore, the pressure is likely to be applied evenly over a panel surface area of the display panel when the substrates are bonded to each other in the process of producing the display panel. The distance between the substrates can be substantially constant. This improves display quality of the display device.

The above display device may further include a lighting device supplying light to the display panel, and the flexible circuit board may have a part other than the section disposed between the substrates and the part may be fixed to the lighting device.

According to such a configuration, the display device can be thinner compared to a configuration that the display panel or the flexible circuit board is away from the lighting device. If the display panel or the flexible circuit board is away from the lighting device, the flexible circuit board may be warped and damaged when the flexible circuit board is mounted on the frame of the display device during the production process of the display device. However, in the above configuration, the flexible circuit board is less likely to be damaged during the production process of the display device.

### Advantageous Effect of the Invention

According to the present invention, a narrow frame is achieved in a display device.

### BRIEF DESCRIPTION OF THE DRAWINGS

FIG. 1 is a schematic plan view of a liquid crystal display device according to a first embodiment.

FIG. 2 is a schematic cross-sectional view of a liquid crystal panel illustrating a cross-sectional configuration along line II-II in FIG. 1.

FIG. 3 is a magnified cross-sectional view of the liquid crystal panel illustrating a connection portion of a flexible circuit board.

FIG. 4 is a cross-sectional view illustrating process (1) of a method of producing the liquid crystal display device according to the first embodiment.

FIG. 5 is a cross-sectional view illustrating process (2) of a method of producing the liquid crystal display device according to the first embodiment.

FIG. 6 is a cross-sectional view illustrating process (3) of the method of producing the liquid crystal display device according to the first embodiment.

FIG. 7 is a cross-sectional view illustrating process (4) of the method of producing the liquid crystal display device according to the first embodiment.

FIG. 8 is a cross-sectional view illustrating process (5) of the method of producing the liquid crystal display device according to the first embodiment.

FIG. 9 is a cross-sectional view illustrating process (6) of the method of producing the liquid crystal display device according to the first embodiment.

FIG. 10 is a cross-sectional view illustrating process (7) of the method of producing the liquid crystal display device according to the first embodiment.

FIG. 11 is a cross-sectional view illustrating process (8) of the method of producing the liquid crystal display device according to the first embodiment.

FIG. 12 is a schematic cross-sectional view of a liquid crystal panel according to a first modification of the first embodiment.

FIG. 13 is a schematic cross-sectional view of a liquid crystal panel according to a second modification of the first embodiment.

FIG. 14 is a magnified cross-sectional view of a liquid crystal panel illustrating a connection portion of a flexible circuit board according to a second embodiment.

FIG. 15 is a cross-sectional view illustrating process (1) of the method of producing a liquid crystal display device according to the second embodiment.

FIG. 16 is a cross-sectional view illustrating process (2) of the method of producing the liquid crystal display device according to the second embodiment.

FIG. 17 is a magnified cross-sectional view of a liquid crystal panel illustrating a connection portion of a flexible circuit board according to a modification of the second embodiment.

FIG. 18 is a schematic plan view of a liquid crystal display device according to a third embodiment.

FIG. 19 is a schematic cross-sectional view of a liquid crystal panel illustrating a cross-sectional configuration along line XVI-XVI in FIG. 17.

FIG. 20 is a schematic plan view of a liquid crystal display device according to a modification of the third embodiment.

FIG. 21 is a magnified cross-sectional view of a liquid crystal panel illustrating a connection portion of a flexible circuit board according to a fourth embodiment.

FIG. 22 is a cross-sectional view illustrating process (1) of the method of producing a liquid crystal display device according to the fourth embodiment.

FIG. 23 is a cross-sectional view illustrating process (2) of the method of producing the liquid crystal display device according to the fourth embodiment.

FIG. 24 is a cross-sectional view illustrating process (3) of the method of producing the liquid crystal display device according to the fourth embodiment.

FIG. 25 is a schematic cross-sectional view of a liquid crystal panel according to a fifth embodiment.

### MODES FOR CARRYING OUT THE INVENTION

### First Embodiment

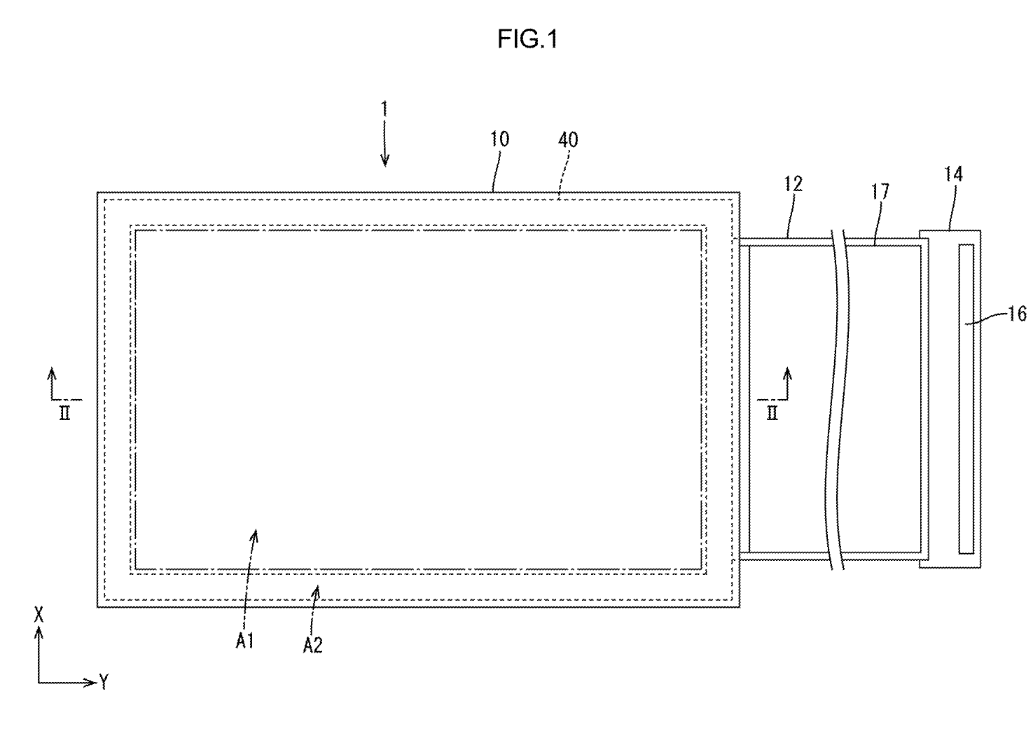

A first embodiment of the present invention will be described with reference to FIGS. 1 to 11. In this section, a method of producing a liquid crystal display device 1 (an example of a display device) will be described. X-axes, Y-axes, and Z-axes may be provided in the drawings. The axes in each drawing correspond to the respective axes in other drawings to indicate the respective directions. An upper side in each cross-sectional view corresponds to an upper side (a front side) of the liquid crystal display device 1.

First, a configuration of the liquid crystal panel 1 and a configuration of a liquid crystal panel 10 will be described. As illustrated in FIG. 1, the liquid crystal display device 1 described in this section includes the liquid crystal panel 10 (an example of a display panel) and a backlight unit (not illustrated) . The liquid crystal panel 10 has a rectangular shape in a plan view. The backlight unit is mounted in the back side portion of the liquid crystal panel 10 and configured to supply light to the liquid crystal panel 10. A large section of the liquid crystal panel 10 is configured as a display area A1 (an area defined by a chain line in FIG. 1). The display area A1 is a horizontally-long area in which images are displayed. A frame-shaped section outside the display area A1 is configured as a non-display area A2 in which images are not displayed. The frame-shaped non-display area A2 is a frame section of the liquid crystal panel 10.

A first end of a flexible circuit board 12 is connected to a first end of the liquid crystal panel 10 in the Y-axis direction (on the right side in FIG. 1). A second end of the flexible circuit board 12 is connected to a control circuit board 14 and an IC chip (an example of a driving component) 16 is mounted on the control circuit board 14. A reinforcing resin film 17 is disposed on a section of the flexible circuit board 12. The IC chip 16 is an electronic component for driving the liquid crystal panel 10. The control circuit board 14 is a circuit board for supplying various kinds of input signals to the IC chip 16.

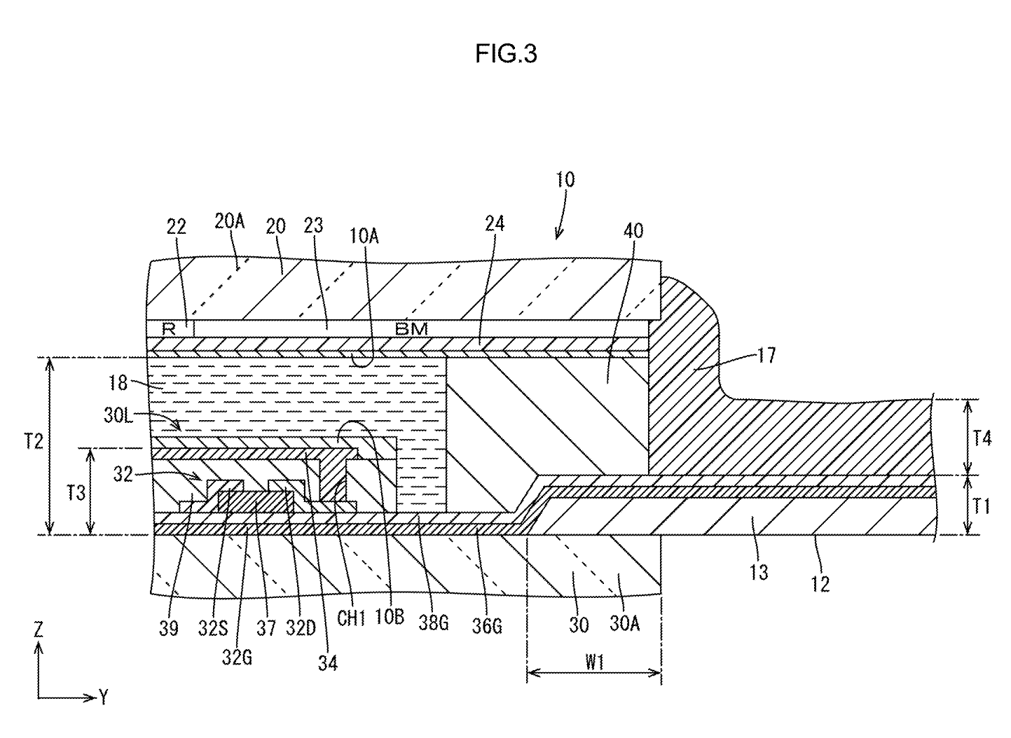

The flexible circuit board 12 has flexibility. As illustrated in FIG. 3, the flexible circuit board 12 is made of yellow opaque resin material including a polyimide film (an example of a first resin film) as a main component. The flexible circuit board 12 includes the opaque resin material, gate lines 36G formed on the polyimide film 13, which will be described later, and a gate insulation film 38G formed on the gate lines 36G, which will be described later. The flexible circuit board 12 is a circuit board that connects the control circuit board 14 and the IC chip 16 to the liquid crystal panel 10 for transmitting the signals from the IC chip 16 to the liquid crystal panel 10. The reinforcing resin film 17 is made of acrylic resin or silicon resin and formed on the flexible circuit board 12 to form a resin film for reinforcing the flexible circuit board 12.

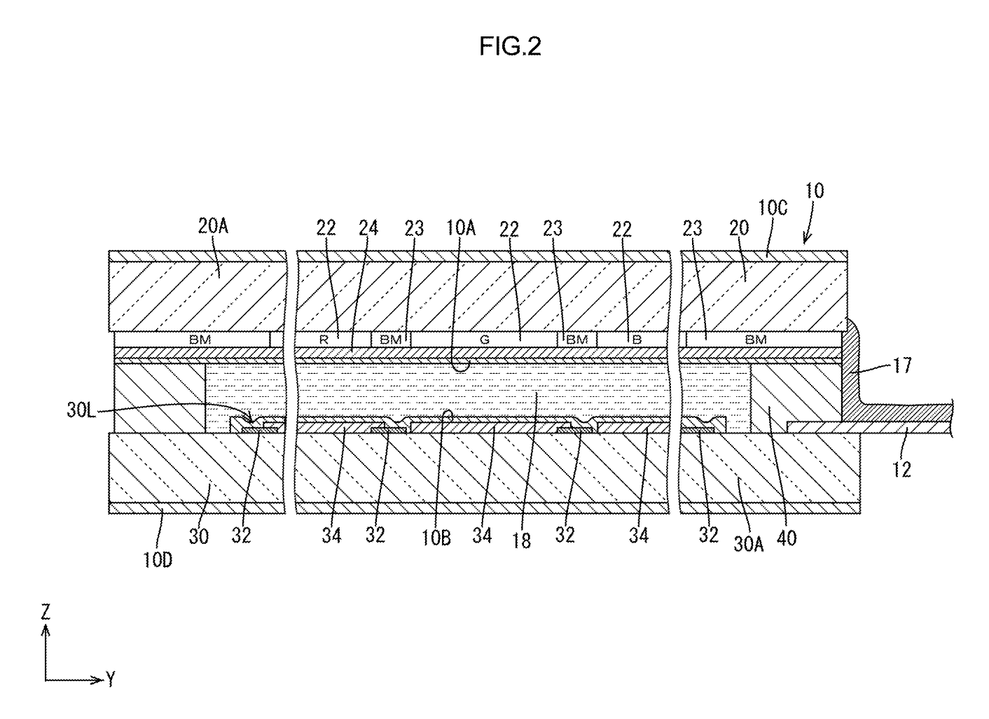

A driving type of the liquid crystal panel 10 is a twisted nematic (TN) type. As illustrated in FIGS. 1 and 2, the liquid crystal panel 10 includes a pair of glass boards 20 and 30 having high light transmissivity and a liquid crystal layer including liquid crystal molecules. The liquid crystal molecules are substances having optical characteristics that change according to an application of an electrical field. The boards 20 and 30 of the liquid crystal panel 10 are bonded together with a cell gap corresponding to a thickness of the liquid crystal layer 18 with an ultraviolet curable type sealant 40. The sealant 40 is in a form of rectangle along outlines of the boards 20 and 30 to surround the liquid crystal layer 18 and thigh film patterns 30L. The first end of the flexible circuit board 12 (the end connected to the liquid crystal panel 10) is disposed to overlap a section of the sealant 40 in the thickness direction of the boards 20 and 30 (the Z-axis direction) of the liquid crystal panel 10. The first end of the flexible circuit board 12 is disposed in a section overlapping only the non-display area A2 of the liquid crystal panel 10 in the Z-axis direction.

The one of the boards 20 and 30 of the liquid crystal panel 10 on the front side is the color filter board 20 (an example of a substrate) and the other on the rear side (the back side) is the array board 30 (an example of a substrate). The color filter board 20 and the array board 30 have dimensions in the X-axis direction about equal to each other and dimensions in the Y-axis direction about equal to each other. Alignment films 10A and 10B for orienting the liquid crystal molecules in the liquid crystal layer 18 are formed on inner surfaces of the boards 20 and 30, respectively. Polarizing plates 10C and 10D are attached to an outer surface of a first glass substrate 20A (an example of a second substrate) included in the color filter board 20 and an outer surface of a second glass substrate 30A (an example of a first substrate) included in the array board 30, respectively. On a first end of the second glass substrate 30A in the Y-axis direction (on the right side in FIGS. 1 and 2), the first end of the flexible circuit board 12 is disposed. A section of the flexible circuit board 12 disposed on the second glass substrate 30A has a width W1 (see FIG. 3) about a few tens of micrometers.

The thin film patterns 30L are formed on the inner surface of the second glass substrate 30A (on the liquid crystal layer 18 side) of the array board 30. The thin film patterns 30L include multiple thin film patterns in layers. Specifically, the thin film patterns 30L include thin film patterns of TFTs 32 that are switching components, thin film patterns of pixel electrodes 34 that are formed above the TFTs 32, and thin film patterns of a part of gate lines (an example of metal lines) 36G and source lines that are arranged in a grid to surround the TFTs and the pixel electrodes 34. Capacitive lines that extend parallel to the gate lines 36G are also routed around the TFTs 32 and the pixel electrodes 34.

The pixel electrodes 34 are transparent electrode films such as indium tin oxide (ITO) films. The pixel electrodes 34 are connected to the TFTs 32 and arranged in a matrix in a plan view. The gate lines 36G are metal lines formed from a single metal film and patterned on the second glass substrate 30A. The source lines are metal lines formed from a metal film and patterned in a layer above the gate lines 36G with a gate insulating film 38G therebetween. As illustrated in FIG. 3, the gate lines 36G and the gate insulating film 38G are continuously formed across the second glass substrate 30A and the flexible circuit board 12. The gate lines 36G extend from the second glass substrate 30A to the control circuit board 14 via the flexible circuit board 12 and ends of the gate lines 36G are connected to the control circuit board. The gate insulating film 38G is made of transparent inorganic material (e.g., silicon oxide film) and patterned to cover entire surfaces of the gate lines 36G to insulate the gate lines 36G from the outside and to protect the gate lines 36G on the flexible circuit board 12 from the outside.

In this embodiment, as illustrated in FIG. 3, a thickness T1 (about 3.5 μm) of the flexible circuit board 12 with the gate lines 36G and the gate insulating film 38G disposed thereon, that is, a total thickness T1 of a thickness of the polyimide film 13, a thickness of the gate lines 36G formed on the polyimide film, and a thickness of the gate insulating film 38G formed on the gate lines is smaller than a gap T2 between the first glass substrate 20A and the second glass substrate 30A. Accordingly, a section of the flexible circuit board 12 can be disposed between the substrates 20, 30. Specifically, the thickness T1 of the flexible circuit board 12 is smaller than the thickness T3 of the thin film patterns 30L. The sealant 40 includes a spacer (not illustrated) that corresponds to the thickness of the liquid crystal layer 18 to keep a space for the thickness of the liquid crystal layer 14, that is, a distance between the upper surface of the thin film patterns 30L and the fist glass substrate 29A.

As illustrated in FIG. 3, the reinforcing resin film 17 has a thickness T4 that is greater than the thickness T1 of the flexible circuit board 12. As illustrated in FIG. 1, the reinforcing resin film 17 is formed on a substantially entire area of a section of the flexible circuit board 12 outside the sealant 40. A first end of the reinforcing resin film 17 covers a part of an end surface of the sealant 12 and extends to a part of an end surface of the first glass substrate 20A (see FIGS. 2 and 3). Accordingly, the strength of the flexible circuit board 12 outside the sealant 40 is ensured by the reinforcing resin film 17.

Next, the TFTs 32 that are the switching components on the array board 30 will be described. Sections of the gate lines 36G overlapping the TFTs 32 in the Z-axis direction are configured as gate electrodes 32G of the TFTs 32. As illustrated in FIG. 3, the TFTs 32 are disposed in a layer above the gate electrodes 32G. Sections of the source lines overlapping the TFTs 32 in the Z-axis direction are configured as source electrodes 32S of the TFTs 32. The TFTs 32 include drain electrodes 32D opposed to the source electrodes 32S with predetermined gaps therebetween in the Y-axis direction to form an island pattern. The drain electrodes 32D are made of the same material as that of the source lines and formed on the array board 30 by patterning in the same process as the source electrodes.

As illustrated in FIG. 3, in each TFT 32, a semiconductor film 37 is formed on the gate insulating film 38G to connect the source electrode 32S to the drain electrode 32D. The semiconductor film 37 may be an amorphous silicon (a-Si) semiconductor film, a low temperature polysilicon (LTPS) semiconductor film, an oxide semiconductor film, or another kind of semiconductor film. The source electrode 32S and the drain electrode 32D are opposed to each other with the predefined gap therebetween and not directly electrically connected to each other. The source electrode 32S and the drain electrode 32D are electrically connected to each other via the semiconductor film in the layer below them. A bridging section of the semiconductor film 37 between the electrodes 32S and 32D functions as a channel through which a drain current flows. Ina layer above the electrodes 32S and 32D and the semiconductor film 37, an interlayer insulating film 39 is formed to cover the electrodes 32S and 32D and the semiconductor film 37. The interlayer insulating film 39 is made of transparent inorganic material and functions as a planarization film for planarizing a surface.

As illustrated in FIG. 3, the interlayer insulating film 39 includes contact holes CH1 at positions overlapping sections of the drain electrodes 32D in the Z-axis direction. The contact holes CH1 are through holes that open in the top-bottom direction. The drain electrodes 32D are exposed through the contact holes CH1. Each pixel electrode 34 is formed in a section above the interlayer insulating film 39 to across the corresponding contact hole CH1. The pixel electrode 34 is connected to the drain electrode 32D via the contact hole CH1. When the pixel electrode 34 is connected to the drain electrode 32D, a voltage is applied to the gate electrode 32G of the TFT 32 (the TFT 32 is turned on), a current flows between the source electrode 32S and the drain electrode 32D via the channel and a predefined voltage is applied to the pixel electrode 34.

The source lines and the capacitive lines are connected to the gate lines 36G at the end of the array board 30 connected to the flexible circuit board 12. A reference voltage or signals are input from the control circuit board to the gate lines 36G, the source lines and the capacitive lines via the gate lines 36G patterned on the flexible circuit board 12. With the reference voltage and the signals, the driving of the TFTs 32 is controlled. As described earlier, the gate lines 36G are continuously formed across the array board 30 and the flexible circuit board 12. Therefore, proper electrical connection is established between the control circuit board 14 and the thin film patterns 30L formed on the array board 30 via the gate lines 30G.

Next, a configuration of the color filter board 20 in the display area A1 of the liquid crystal panel 10 will be described. As illustrated in FIG. 2, color filters 22 are disposed on the inner surface of the first glass substrate 20A (on the liquid crystal layer 18 side) of the color filter board 20 at positions overlapping the pixel electrodes 34 of the array board 30 in the plan view. The color filters 22 are arranged in a matrix. The color filters 22 include red (R), green (G), and blue (B) color sections. A light blocking section 23 (a black matrix) for reducing color mixture is formed in a grid among the color sections of the color filters 22. The light blocking section 23 overlaps the gate lines 36G (except for those on the flexible circuit board 12), the source lines, and the capacitive lines on the array board 30 in the plan view.

In the liquid crystal panel 10, a red (R) color section, a green (G) color section, a blue (B) color section, and three pixel electrodes 34 opposed to them form a single display pixel, which is a display unit. The display pixel includes a red pixel including the R color section, a green pixel including the G color section, and a blue pixel including the B color section. Pixels in those colors are repeatedly arranged in the row direction (the X-axis direction) on a plate surface of the liquid crystal panel 10 to form lines of pixels. The lines of pixels are arranged in the column direction (the Y-axis direction). As illustrated in FIG. 2, a counter electrode 24 is formed on inner surfaces of color filters 22 and light blocking sections 23 to be opposed to the pixel electrodes 34 on the array board 30. The counter electrode is connected to a counter electrode line, which is not illustrated, in the non-display area A2 of the liquid crystal panel 10. A reference voltage is applied to the counter electrode 24 via the counter electrode line. By controlling the voltage applied to the pixel electrodes 34 by the TFTs 32, a predefined voltage difference is produced between the pixel electrodes 34 and the counter electrode 24.

In the liquid crystal panel 10 in this embodiment, the first end of the flexible circuit board 12 is disposed to overlap the section of the sealant 40 in the Z-axis direction. Therefore, it is not necessary to configure the array board 30 to project outward from the sealant 40 for connecting the flexible circuit board 12 to the liquid crystal panel 10. Namely, a mounting area for mounting the flexible circuit board 12 is not required outside the sealant 40. As illustrated in FIGS. 2 and 3, the end surfaces of the glass substrates 20A and 30A of the color filter board 20 and the array board 30 are substantially flush with end surfaces of the sealant 40. According to the configuration, a narrow frame can be provided.

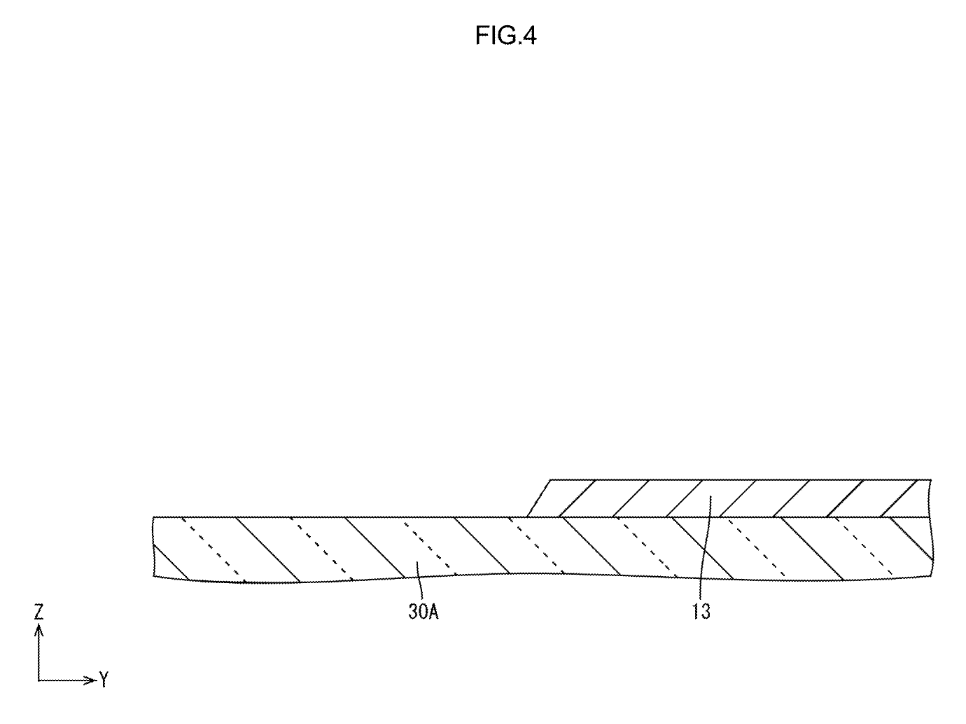

The configuration of the liquid crystal panel 10 according to this embodiment is described above. Next, the method of producing the liquid crystal panel 10 having the configuration described above will be described. In this section, a method of producing the array board 30 will be described especially in detail. First, the method of producing the array board 30 will be described. As illustrated in FIG. 4, in a production process of the array board 30 in this embodiment, the polyimide film 13 of the flexible circuit board 12 is formed on a section of the second glass substrate 30A using a known lithography method. Namely, the polyimide film 13 is formed on an entire area of the second glass substrate 30A and patterned to form the flexible circuit board 12 (a first resin film forming process). The thickness of the polyimide film 13 to be formed is adjusted according to the thickness T1 (see FIG. 3). The flexible circuit board 12 may be formed by applying the polyimide film on the second glass substrate 30A by screen printing instead of the photolithography method.

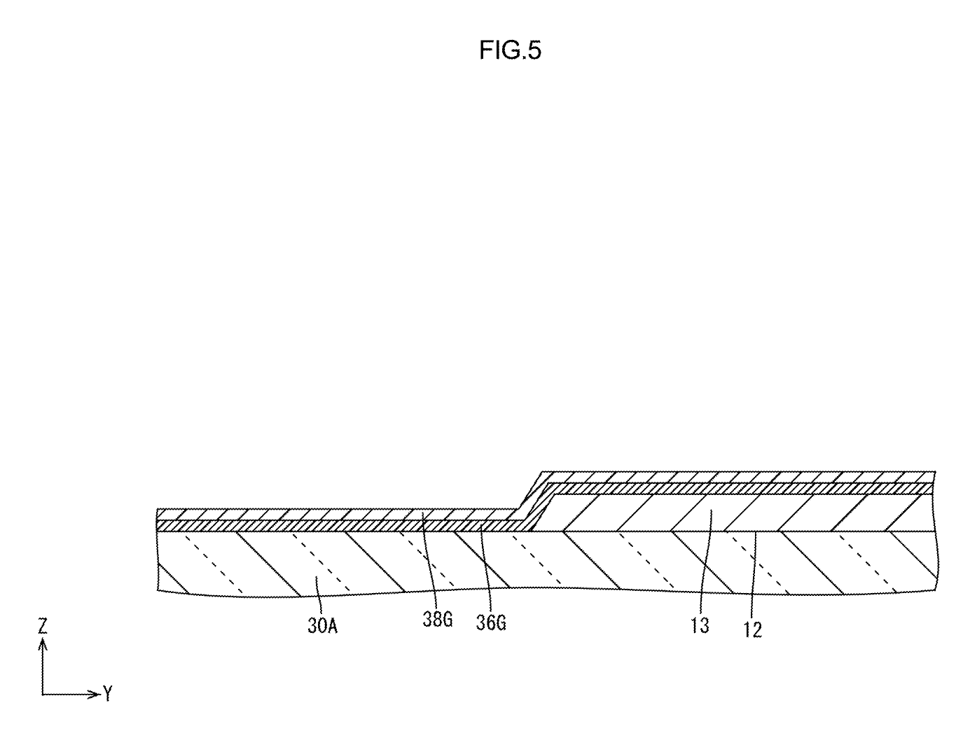

Next, as illustrated in FIG. 5, the gate lines 36G are formed on the second glass substrate 30A and on the polyimide film 13 through patterning using the known lithography method (a metal line forming process). The gate insulating film 38G is formed such that distal ends of the gate lines 36G extending onto the polyimide film 13 from the array board 30 side are exposed from the gate insulating film 38G. Thus, the flexible circuit board 12 including the polyimide film 13, the gate lines 36G, and the gate insulating film 38G and having flexibility is formed.

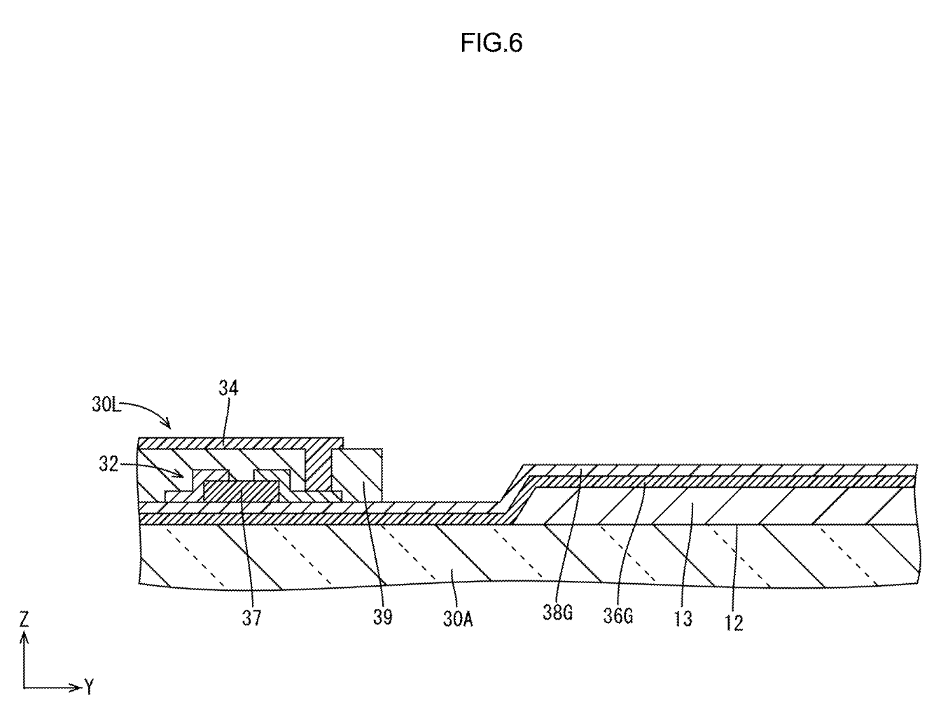

Next, as illustrated in FIG. 6, the source lines formed through patterning and the semiconductor film 37 are formed on the second glass substrate 30A (on the gate insulating film 38G) to form the TFTs 32 in other sections of the second glass substrate 30A (in the sections in which the flexible circuit board 12 is not formed) . Sections of the source lines formed through patterned and overlapping the TFTs 32 are configured as the source electrodes 32S and the drain electrodes 32D. Sections of the gate lines 36G formed through patterned and overlapping the TFTs 32 are configured as gate electrodes 32G.

In the process for forming the TFTs 32 on the array board 30, a post-exposure bake may be performed to increase adhesion between the films of the TFTs 32. In the post-exposure bake, the second glass substrate 30A is subjected to heat treatment at high temperature (e.g., about 400° C.) . The decomposition temperature of the polyimide, which is a material of the flexible circuit board 12, is 500° C. or higher, that is, the polyimide has higher heat resistance in comparison to regular polymers. Therefore, even if the post-exposure bake is performed in the formation of the TFTs 32 after the formation of the flexible circuit board 12 as in this embodiment, the material of the flexible circuit board 12 is less likely to be decomposed by heat, that is, an adverse effect is less likely to be exerted on the flexible circuit board 12.

As illustrated in FIG. 6, the interlayer insulating film 39 is formed through patterning to cover the TFTs 32 and planarize the surfaces of the TFTs 32. The thickness of the interlayer insulating film 39 is adjusted according to the thickness T2 (see FIG. 3) . The pixel electrodes 34 are formed on the surface of the interlayer insulating film 39 through patterning. Through the steps described above, the thin film patterns 30L including multiple thin film patterns in layers on the second glass substrate 30A of the array board 30 are formed (a pattern forming process). The alignment film 10B is formed on the surfaces of the interlayer insulating film 39 and the pixel electrodes 34. Through the above steps, the array board 30 is complete. In this embodiment, the gate lines 36G and the thin film patterns 30L can be continuously formed only by changing the photomask to be used and therefore, the metal line forming process and the pattern forming process can be performed in the same process.

A method of producing the color filter board 20 will be briefly described. In a production process of the color filter board 20, the light blocking section 23 that is a thin film is formed on the first glass substrate 20A and processed into a grid by the photolithography method. The light blocking section 23 is made of titanium, for example. The color sections of the color filters 22 are formed at predefined positions. The counter electrode 24 is formed to cover the light blocking section 23 and the color filters 22. A transparent insulating film (not illustrated), which is a protective film, is formed to cover the counter electrode. The insulating film is made of silicon dioxide, for example. The alignment film 10A is formed on the surface of the insulating film. Through the above steps, the color filter board 20 is complete.

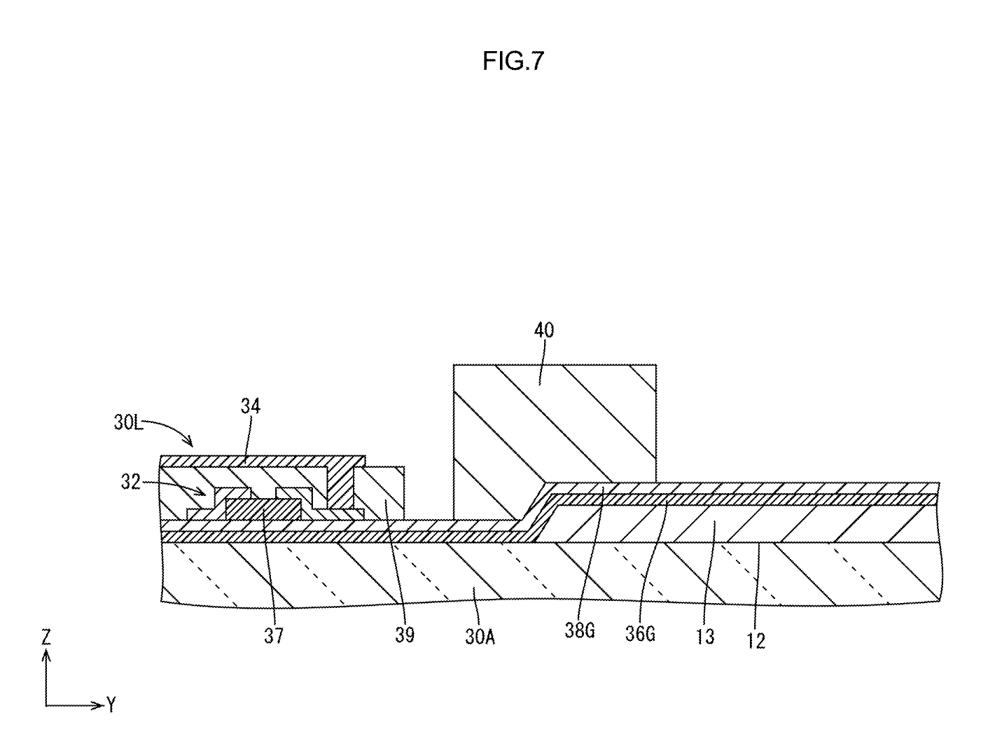

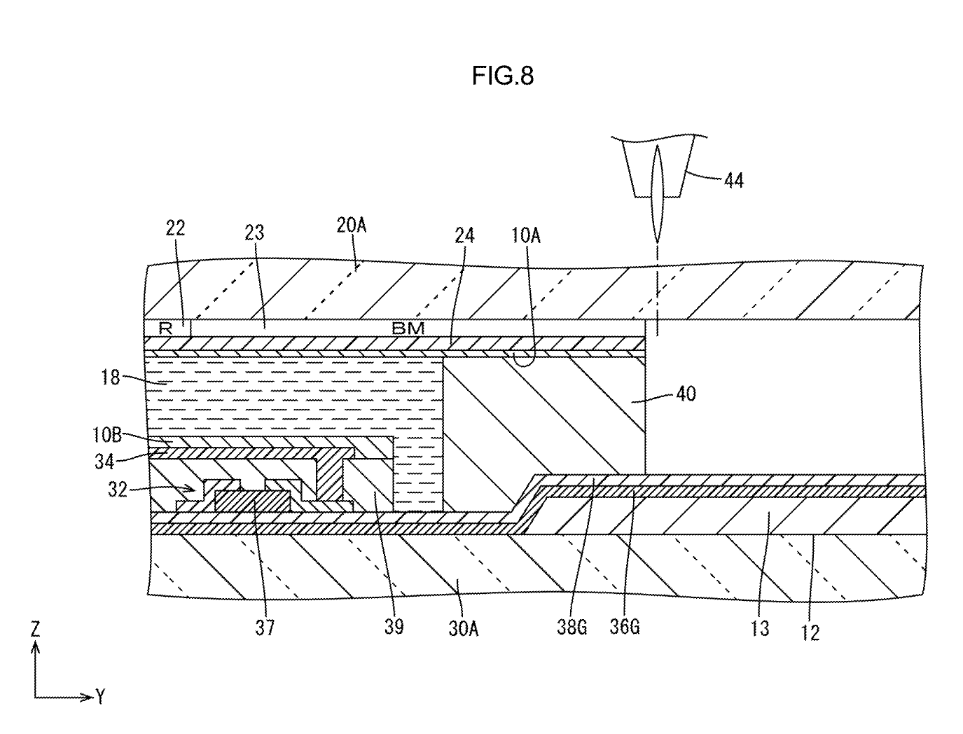

After the array board 30 and the color filter board 20 are complete, the sealant 40 is applied onto the second glass substrate 30A in a form of a rectangle along the outline of the second glass substrate 30A. As illustrated in FIG. 7, the sealant 40 is applied onto the second glass substrate 30A while adjusting application positions such that a section of the sealant 40 overlaps the first end of the flexible circuit board 12 in the Z-axis direction and the width of the overlapping section of the flexible circuit board 12 is equal to the width W1 described earlier. The first glass substrate 20A of the color filter board 20 is set opposite the second glass substrate 30A and positioned such that the end surface of the first glass substrate 20A is aligned with the end surface of the second glass substrate 30A. The liquid crystals are injected into a section of the second glass substrate 30A surrounded by the sealant 40 by the one drop fill (ODF) method using a liquid crystal dropping device to form the liquid crystal layer 18. The amount of the liquid crystals to be injected is adjusted according to the thickness T3. As illustrated in FIG. 8, the first glass substrate 20A is held opposite the second glass substrate 30A and bonded to the second glass substrate 30A with the sealant 40 (a bonding process).

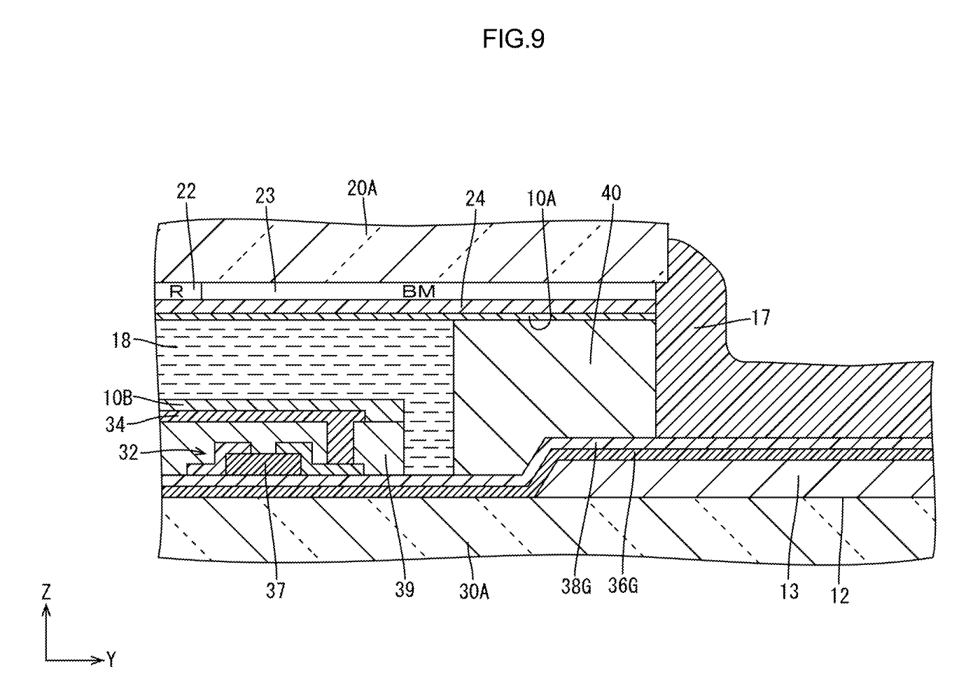

As illustrated in FIG. 8, the first glass substrate 20A is cut at a boundary between a section outside the sealant 40 and other section using a scriber 44 to remove the section of the first glass substrate 20A outside the sealant 40 (a second substrate removing process). As illustrated in FIG. 9, the reinforcing resin film 17 is formed on a substantially entire area of the section of the flexible circuit board 12 outside the sealant 40 having the gate lines 36G and the gate insulating film 38G therebetween (a second resin film forming process). In the second resin film forming process, the resin of the reinforcing resin film 17 is applied to have a thickness greater than the flexible circuit board 12 such that the first end of the reinforcing resin film 17 covers a part of the end surface of the sealant 40 and extends to a part of the end surface of the first glass substrate 20A. Thus, the reinforcing resin film 17 is formed. The resin used for the reinforcing resin film 17 is preferably hardened at a normal temperature or hardened by ultraviolet rays such that display quality of the liquid crystal display device 1 to be produced is less likely to be adversely affected.

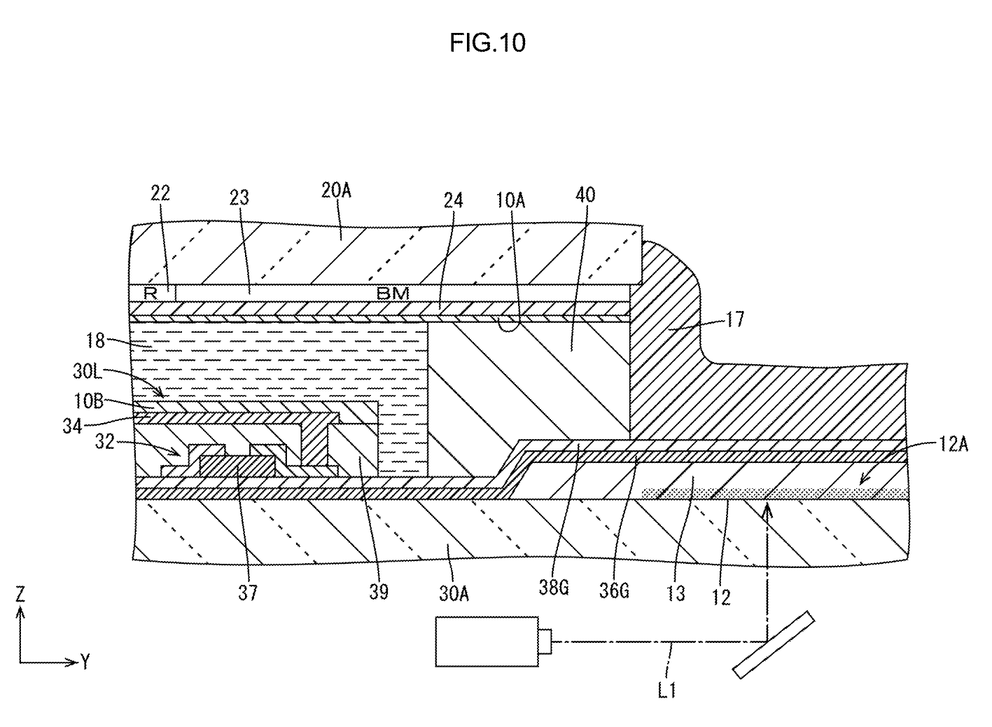

As illustrated in FIG. 10, a laser beam L1 is applied to a section of the boundary between the second glass substrate 30A and the flexible circuit board 12 outside the sealant 40 by a laser beam applying unit 42 (a light applying process). As a result, a weak layer 12A is formed in a section of the flexible circuit board 12 to which the laser beam L1 is applied. The weak layer 12A may be formed by applying a metal film of titanium or molybdenum near the boundary between the second glass substrate 30A and the polyimide film of the flexible circuit board 12 in the first resin film forming process and applying the laser L1 to the metal film. Thus, the weak layer 12A may be formed with heat generated by the application of the laser beam L1. Accordingly, the laser beam L1 is applied to the metal film and the laser beam L1 is not directly applied to the polyimide film. Therefore, the polyimide film is less likely to be damaged or broken by the laser beam L1.

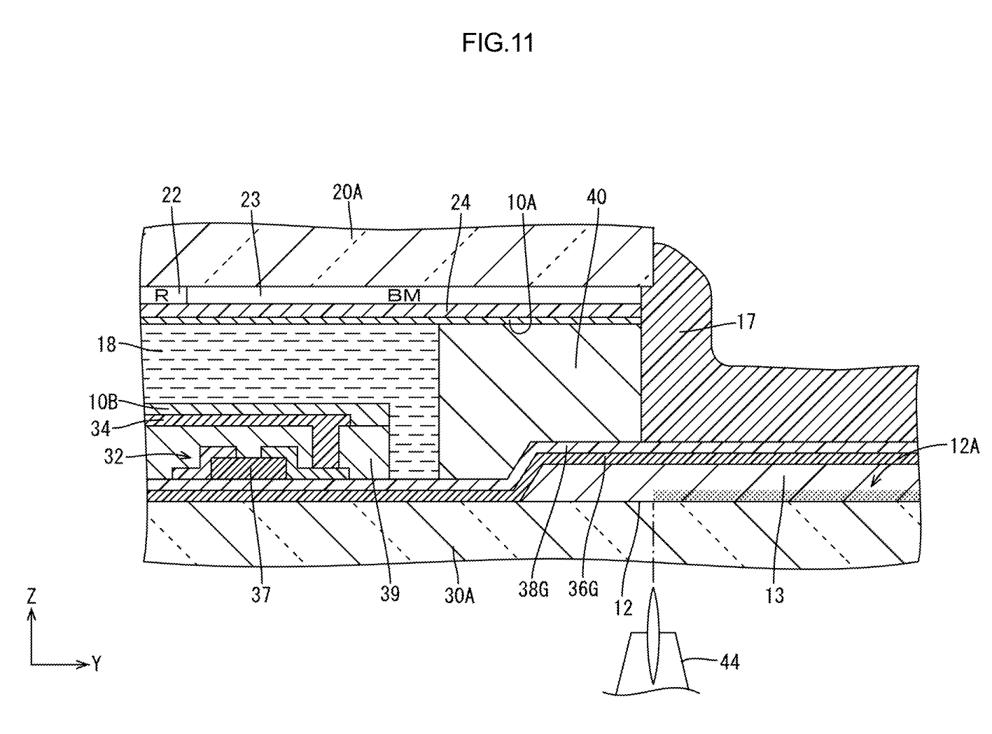

As illustrated in FIG. 11, with using the scriber 44 similarly to the second substrate removing process, the second glass substrate 30A is cut at a boundary between the section outside the sealant 40 and other section such that the section of the second glass substrate 30A outside the sealant 40 can be separated and removed from the flexible circuit board 12 (a first substrate removing process). Because the weak layer 12A is formed in the flexible circuit board 12, the section of the second glass substrate 30A can be easily removed from the flexible circuit board 12.

The polarizing plates 10C and 10D are bonded to the outer surfaces of the glass substrates 20A and 30A and the second end of the flexible circuit board 12 is connected to the control circuit board 14. The ends of the gate lines 36G are uncovered by the gate insulating film 38G and connected to the control circuit board 14. The IC chip 16 is mounted on the control circuit board 14. In the mounting process, the IC chip 16 is mounted on the section outside the sealant 40 and except for the flexible circuit board 12. This completes the liquid crystal panel 10. The backlight unit is fixed to the back of the liquid crystal panel 10. This completes the liquid crystal display device 1 according to this embodiment.

As described above, in the method of producing the liquid crystal panel 10 in this embodiment, the thin film patterns 30L including multiple thin film patterns are formed in the other section of the second glass substrate 30A in the pattern forming process. The sections of the gate lines 36G formed in the other section of the second glass substrate 30A are configured as the gate electrodes 32G of the TFTs 32. In the metal line forming process, the gate lines 36G are formed to continue from the other section of the second glass substrate 30A to the polyimide film 13. The polyimide film 13 formed in the section of the second glass substrate 30A in the first resin film forming process is configured as the flexible circuit board 12 for transmitting the signals for driving the produced liquid crystal display device 1. According to the method, the flexible circuit board 12 is connected onto the second glass substrate 30A without press-bonding the first end of the flexible circuit board 12 onto the second glass substrate 30A.

The bonding process is performed after the above-described processes. As described above, the sealant 40 can be applied such that the first end of the flexible circuit board 12, that is, the connecting section of the flexible circuit board 12 and the second glass substrate 30A is located at a position overlapping the sealant 40 in the Z-axis direction. In the second substrate removing process and the first substrate removing process, about entire sections of the first glass substrate 20A and the second glass substrate 30A outside the sealant 40 can be removed without having need for maintaining mounting areas for mounting the flexible circuit board outside the sealant as in the known technology. In comparison to the known liquid crystal display device including the mounting area for mounting the flexible circuit board outside the sealant, the frame width of the liquid crystal display device 1 can be reduced.

In the liquid crystal display device 1 produced with the method of this embodiment, the sealant 40 includes a spacer having a size corresponding to the thickness of the liquid crystal layer 18. If a total of the thicknesses of the polyimide film 13 of the flexible circuit board 12, the gate lines 36G, and the gate insulating film 38G is greater than the thickness of the thin film patterns T3, the flexible circuit board 12 may push up the first glass substrate 20A via the spacer in the section of the flexible circuit board 12 overlapping the sealant 40, and a distance between the first glass substrate 20A and the second glass substrate 30A may not be maintained proper.

According to the method of this embodiment, in the metal line forming process, the gate lines 36G formed through patterning are continuously formed on the second glass substrate 30A and the polyimide film 13. If the thickness of the polyimide film 13 is great and accordingly the thickness of the flexible circuit board 12 is great, a great difference in level may be created between an upper surface of the second glass substrate 30A and an upper surface of the polyimide film 13. If such great difference is created, a photoresist film formed at the boundary between the second glass substrate 30A and the polyimide film 13 is thicker than the photoresist film formed on other sections. An unnecessary photoresist film may remain at the boundary. As a result, an etching failure of the metal film may be caused and short-circuit may occur between the gate lines 36G at the section where the photoresist film remains.

According to the method of this embodiment, the polyimide film 13 of the flexible circuit board 12, the gate lines 36G, and the gate insulating film 38G are formed such that a total of the thicknesses of the polyimide film 13, the gate lines 36G, and the gate insulating film 38G. Therefore, problems that a proper distance cannot be maintained between the first glass substrate 20A and the second glass substrate 30A or a short-circuit occurs between the gate lines 36G are less likely to be caused. According to the method of this embodiment, even when a quite thin flexible circuit board 12 is formed, the reinforcing resin film 17 is formed on the polyimide film 13 outside the sealant 40 in the second resin film forming process such that the strength of the section of the flexible circuit board 12 outside the sealant 40 can be reinforced by the reinforcing resin film 17.

The polyimide film of the flexible circuit board 12 is opaque. If a section of the flexible circuit board 12 overlaps the display area A1 of the liquid crystal panel 10, a display failure may occur in the overlapping area. In the liquid crystal display device 1 produced by the method in this embodiment, the first end of the flexible circuit board 12 overlaps only the non-display area A2 of the liquid crystal panel 10 in the Z-axis direction. Therefore, such a display failure or degradation in display quality is less likely to occur.

In the method of this embodiment, as described before, the metal line forming process and the pattern forming process can be performed in the same process. The production process is shortened compared to the method in which the forming of the gate lines 36G and the forming of the thin film patterns 30L are performed in different processes.

In the known display device including the gate lines on the TFTs and the pattern lines on the control circuit board are connected to each other via the ACF, electric resistance is high at the ACF according to the mounting pattern of the ACF, and the proper electric connection may not be established between the gate lines on the TFTs and the pattern lines on the control circuit board. According to the method of producing the liquid crystal display device 1 of this embodiment, in the metal line forming process, the metal lines of gate lines 36G are formed continuously from the TFTs 32 on the second glass substrate 30A to the control circuit board 14 via the flexible circuit board 12, as described earlier. In comparison to the known display device, the proper electric connection is established between the gate lines 36G on the TFTs 32 and the pattern lines on the control circuit board 14.

### First Modification of First Embodiment

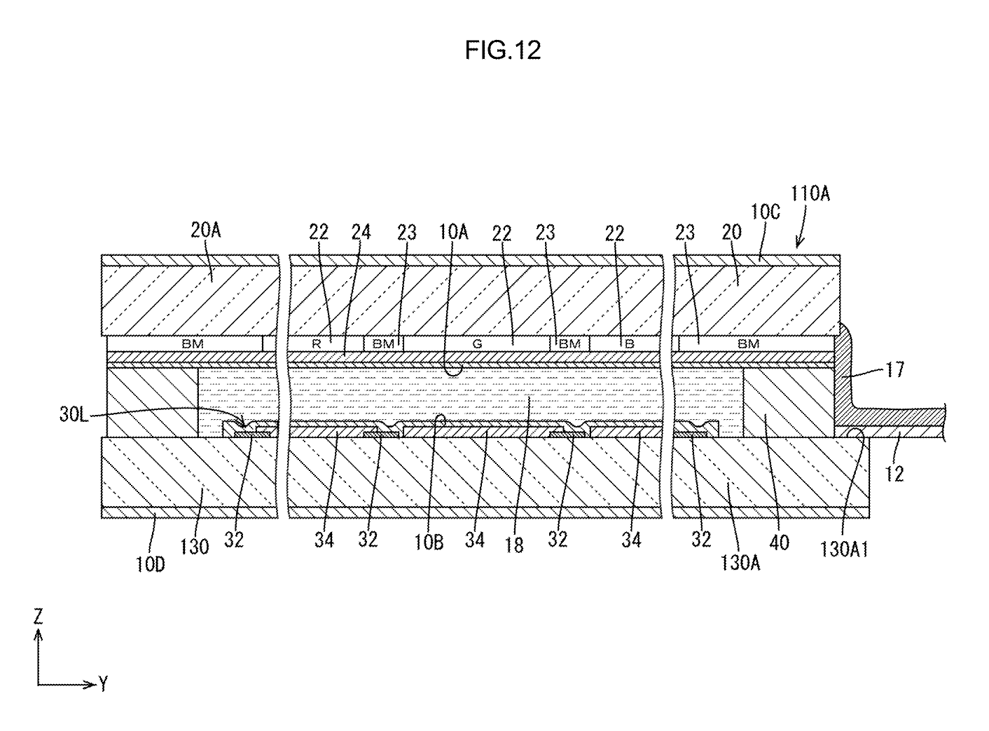

A first modification of the first embodiment will be described with reference to FIG. 12. A liquid crystal display device according to this modification differs from the first embodiment in a connection position of the flexible circuit board 12 to a liquid crystal panel 110A. Other configurations are similar to those of the liquid crystal display device 1 of the first embodiment. As illustrated in FIG. 10, in the liquid crystal panel 110A of this modification, an end surface of the array board 130 that is connected to the flexible circuit board 12 projects outwardly from an end surface of the color filter board 20. A first end of the flexible circuit board 12 is disposed on a projected section (a section represented by 130A1 in FIG. 10) and connected to the liquid crystal panel 110A such that an end surface of the flexible circuit board 12 is close to an outer surface of the sealant 40. The reinforcing resin film 17 is formed on a substantially entire area of the section of the flexible circuit board 12 outside the sealant 40 similarly to the first embodiment. The first end of the reinforcing resin film 17 extends to a part of the end surface of the first glass substrate 20A.

The liquid crystal panel 110A having the above configuration according to this modification is produced as described below. In the bonding process, the sealant 40 is applied onto the second glass substrate 130A while adjusting application positions such that an outer surface of a section of the sealant 40 is disposed close to the end surface of the first end of the flexible circuit board 12. In the first substrate removing process, a section of the second glass substrate 130A is removed while keeping the projected section 130A1 outside the sealant 40. Other production steps are same as those of the first embodiment. In the liquid crystal display device according to this modification produced as described before, the first end of the flexible circuit board 12 can be connected to the liquid crystal panel 110A, if the projected section 130A1 has a width of about a few tens of micrometers. Therefore, a narrower frame is achieved compared to the known liquid crystal display device having the mounting area for the flexible circuit board outside the sealant.

### Second Modification of First Embodiment

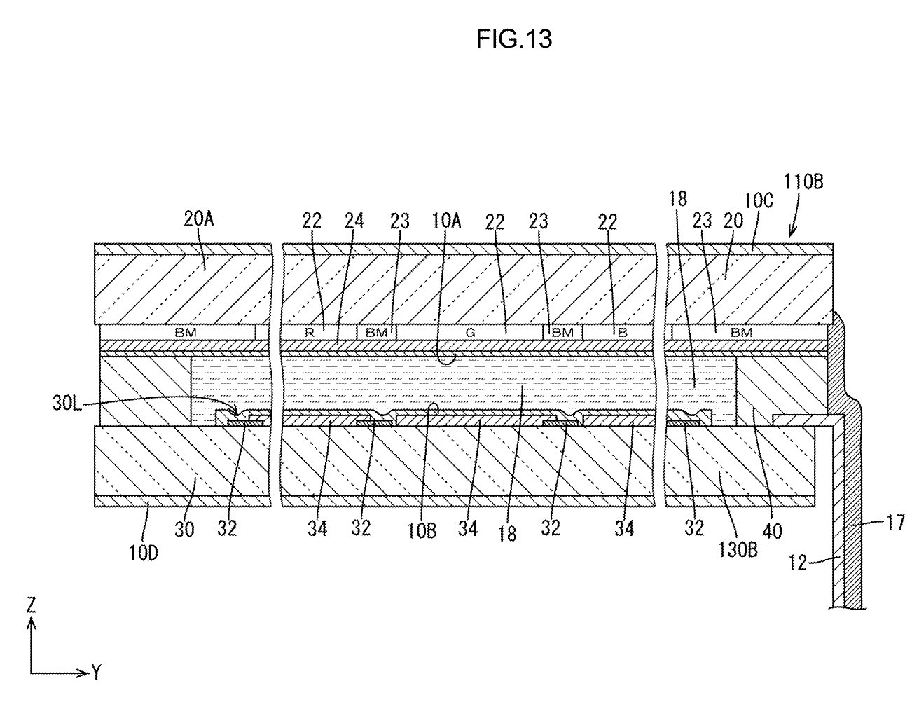

A second modification of the first embodiment will be described with reference to FIG. 13. A liquid crystal display device according to this modification includes a second glass substrate 30A having a size different from the first embodiment. Other configurations are similar to the first embodiment. In this modification, as illustrated in FIG. 13, a liquid crystal panel 110B includes a second glass substrate 130B having a size smaller than that of the first embodiment. Specifically, the second glass substrate 130B has an end surface (an end surface on a right side in FIG. 12) from which the resin film 12 extends outside the sealant 40. The end surface is inside the outer surface of the sealant and overlaps the sealant 40 with respect to the Z-axis direction.

The second glass substrate 130B according to this modification has the above size. With such a configuration, the section of the flexible circuit board 12 outside the sealant 40 is folded downwardly as illustrated in FIG. 12, and a gap S1 is provided between an end surface of the second glass substrate 130B and the folded section of the flexible circuit board 12. The reinforcing resin film 17 is formed on a substantially entire area of the folded section of the flexible circuit board 12 outside the sealant 40 similarly to the first embodiment. Further, the first end of the reinforcing resin film 17 extends to a part of the end surface of the first glass substrate 20A. In this modification, the end surface of the second glass substrate 130B and the folded section of the flexible circuit board 12 do not contact each other because of the gap S1. Therefore, in the liquid crystal display device of this modification, the folded section of the flexible circuit board 12 is less likely to be damaged by the end surface of the second glass substrate 130B.

### Second Embodiment

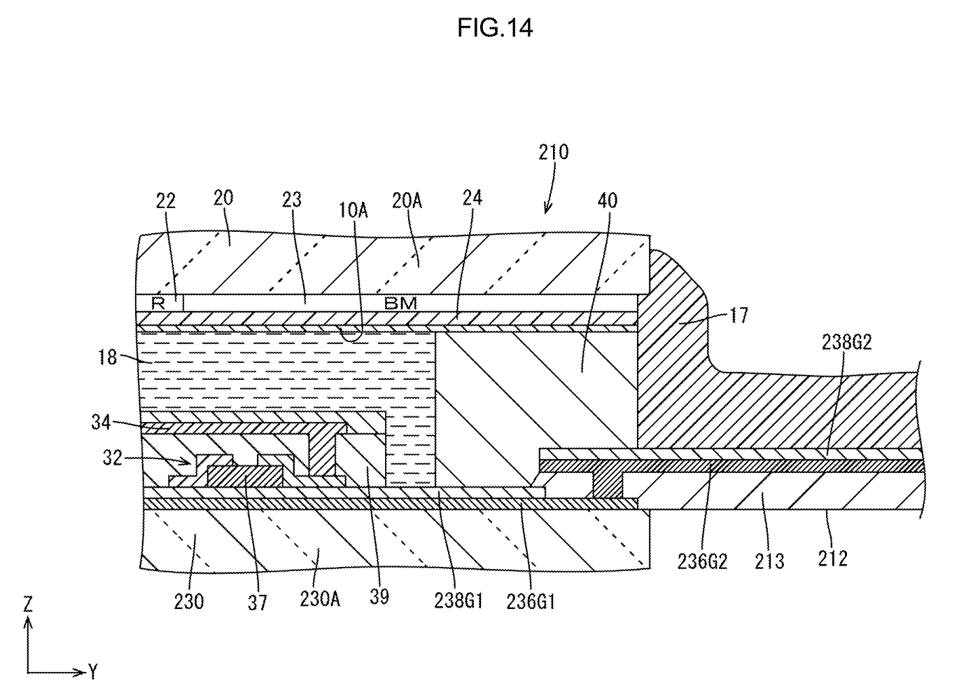

A second embodiment will be described with reference to FIGS. 14 to 16. A liquid crystal display device according to this embodiment includes gate lines 236G1 and 236G2 that are continuously formed on a second glass substrate 230A and a flexible circuit board 212, and the gate insulating film 238G, which are different from the first embodiment. Other configurations are similar to those of the first embodiment and thus will not be described. In this embodiment, as illustrated in FIG. 14, the gate lines 236G1 and 236G2 and the gate insulating films 238G1, 238G2 of a liquid crystal panel 210 include the first gate lines 236G1 and the first gate insulating film 238G1 formed on the second glass substrate 230A of an array board 230 and second gate lines 236G2 and second gate insulating film 238G2 formed on the flexible circuit board 212. The forming of the reinforcing resin film 17 is similar to the first embodiment.

Specifically, the first gate lines 236G1 and the first gate insulating film 238G1 extends to an end of the second glass substrate 230A where the flexible circuit board 212 is connected and the first gate lines 236G1 projects further than the first gate insulating film 238G1 at the end. The first end of the flexible circuit board 212 is disposed on the second glass substrate 230A to cover the projected section of the first gate lines 236G1. The first end of the flexible circuit board 212 includes a contact hole CH2 that is through in the top-bottom direction. The first gate lines 236G1 inside the contact hole CH2 are exposed.

The second gate lines 236G2 are formed on the flexible circuit board 212 to cross the contact hole CH2. First ends of the second gate lines 236G2 are electrically connected to the first gage lines 236G1 via the contact hole CH2 and second ends of the second gate lines 236G2 are electrically connected to a control circuit board, which is not illustrated. The second insulating film 238G2 is formed on the second gate lines 236G2 to cover the second gate lines 236G2. With such a configuration, the metal lines of the first gate lines 236G1 and the second gate lines 236G2 are formed continuously from the array board 230 to the flexible circuit board 212.

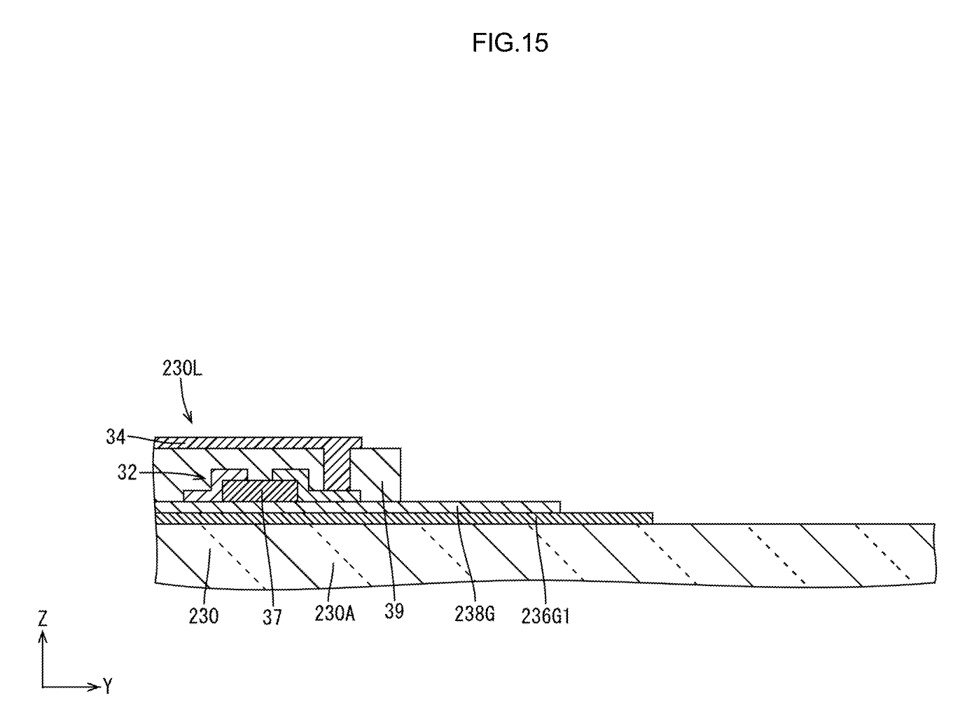

Next, a method of producing the liquid crystal panel 210 having the above configuration will be described. As illustrated in FIG. 15, the first gate lines 236G1 formed through patterning are formed on a section of the second glass substrate 230A of the array board 230 and the first gate insulating film 238G1 that is formed through pattering on the first gate lines 236G1 such that the first end of the first gate lines 236G1 projects further from the first insulating film 238G1 (a metal line forming process). Then, the TFTs 32 are formed on the section of the second glass substrate 230A and the interlayer insulating film 39 formed through patterning and the pixel electrodes 34 formed through pattering are formed in sequence (a pattern forming process). In this embodiment, unlike the first embodiment, thin film patterns 230L including the TFTs 32 are formed on the second glass substrate 230A before forming the flexible circuit board 212 on the second glass substrate 230A.

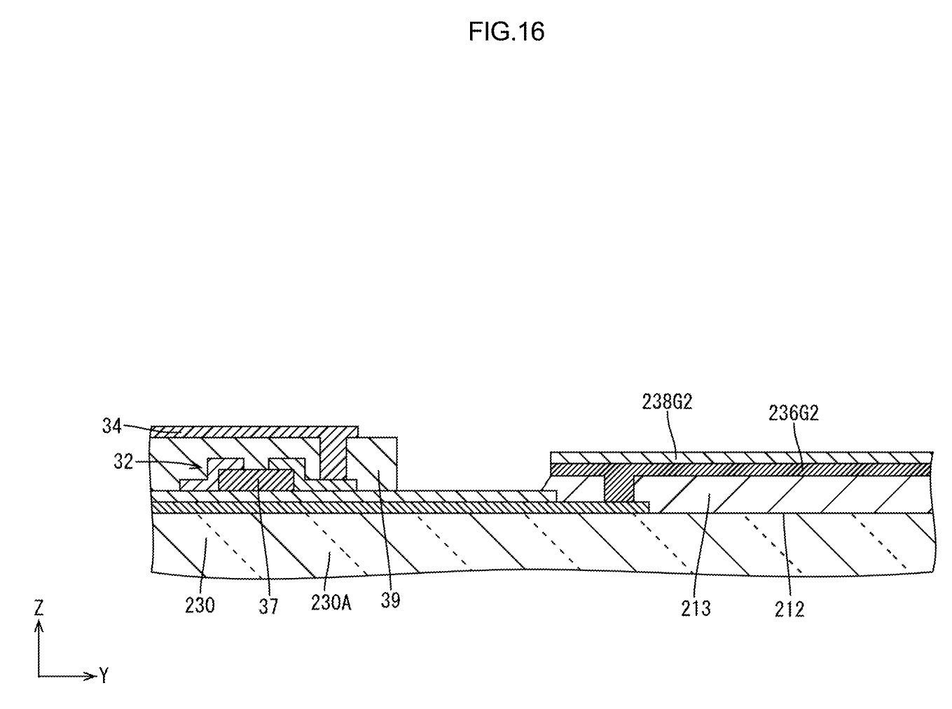

Next, as illustrated in FIG. 16, the flexible circuit board 212 formed through patterning is formed on a section of the second glass substrate 230A to cover the first end of the first gate lines 236G1 projecting from the gate insulating film 238G (a first resin film forming process). Then, the contact hole CH2 is formed in the first end of the flexible circuit board 212 and the first end of the first gate lines 236G1 within the hole is exposed. Next, the second gate lines 236G2 are formed on the flexible circuit board 212 to cross the contact hole CH2 and the second gate insulating film 238G2 is formed on the second lines 236G2 to cover the second gate lines 236G2 (a metal line forming process). Thereafter, similarly to the first embodiment, the boding process, the light applying process, the second substrate removing process, the second resin film forming process, and the first substrate removing process are performed. Through the processes, the liquid crystal panel 210 in this embodiment is complete.

In this embodiment, the metal lines that are formed continuously from the section of the second glass substrate 230A to the flexible circuit board 212 are configured by the first gate lines 236G1 and the second gate lines 236G2. The flexible circuit board 212 is connected onto the second glass substrate 230A without press-bonding the first end of the flexible circuit board 212 onto the second glass substrate 230A. In the bonding process, the sealant 40 can be applied such that the first end of the flexible circuit board 212 is located inside the sealant 40 or near the sealant 40. In the second substrate removing process and the first substrate removing process, as illustrated in FIG. 14, a substantially entire area of the sections of the first glass substrate 220A and the second glass substrate 230A outside the sealant 40 can be removed and the liquid crystal display device 1 having a narrow frame can be produced.

In the method of this embodiment, even if the post-exposure bake is performed in the formation of the TFTs 32 before the formation of the flexible circuit board 212 on the second glass substrate 230A to form the thin film patterns 230L on the second glass substrate 230A, the material of the flexible circuit board 212 is less likely to be decomposed by heat. Therefore, resin material having low heat resistant properties can be used for the material of the flexible circuit board 212 and this provides a wide variety of materials that can be used. For example, transparent polyimide having good photosensitive properties and good light transmissivity can be used for the material of the flexible circuit board 212 and this simplifies or shortens the production process. Further, a device of forming the thin film patterns of the TFTs 32 is less likely to be damaged by organic material included in the flexible circuit board 212.

### Modification of Second Embodiment

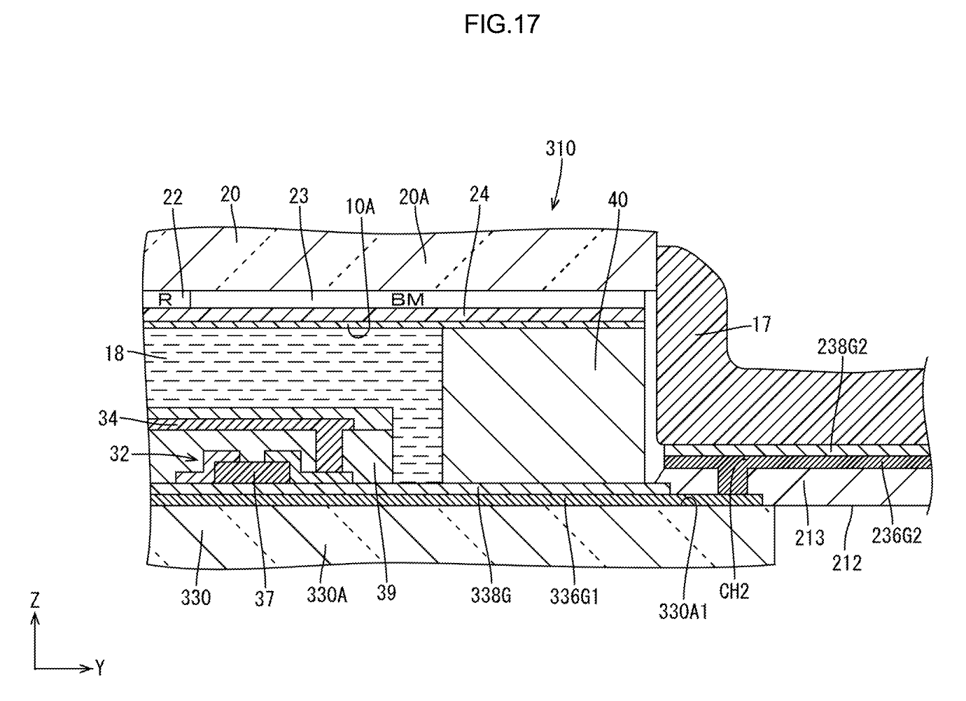

A Modification of the second embodiment will be described with reference to FIG. 17. In a liquid crystal display device of this modification, a connection position of the flexible circuit board 212 to a liquid crystal panel 310 differs from the second embodiment. Other configurations are similar to those of the liquid crystal display device of the second embodiment. As illustrated in FIG. 16, in the liquid crystal panel 310A of this modification, an end surface of the array board 330 that is connected to the flexible circuit board 212 projects outwardly from an end surface of the color filter board 20. A projected section of the first gate lines 336G projecting from the first gate insulating film 338G1 is disposed on the projected section of the array board 330 outside the sealant 40. A first end of the flexible circuit board 212 is disposed on the projected section (a section represented by 330A1 in FIG. 16) and connected to the liquid crystal panel 310 such that a first end surface of the flexible circuit board 212 is close to an outer surface of the sealant 40.

The liquid crystal panel 310 having the above configuration according to this modification is produced as described below. In the metal line forming process, the first gate lines 336G1 are formed through patterning to extend to the projected section 330A1. In the bonding process, the sealant 40 is applied onto the second glass substrate 330A while adjusting application positions such that an outer surface of a section of the sealant 40 is disposed close to the end surface of the first end of the flexible circuit board 212. In the first substrate removing process, a section of the second glass substrate 330A is removed while keeping the projected section 330A1 outside the sealant 40. Other production steps are same as those of the first embodiment. In the liquid crystal display device according to this modification produced as described before, the first end of the flexible circuit board 212 can be connected to the liquid crystal panel 310, if the projected section 330A1 has a width of about a few tens of micrometers in addition to the gap between the outer surface of the sealant and the flexible circuit board 212. Therefore, a narrower frame is achieved compared to the known liquid crystal display device having the mounting area for the flexible circuit board outside the sealant.

### Third Embodiment

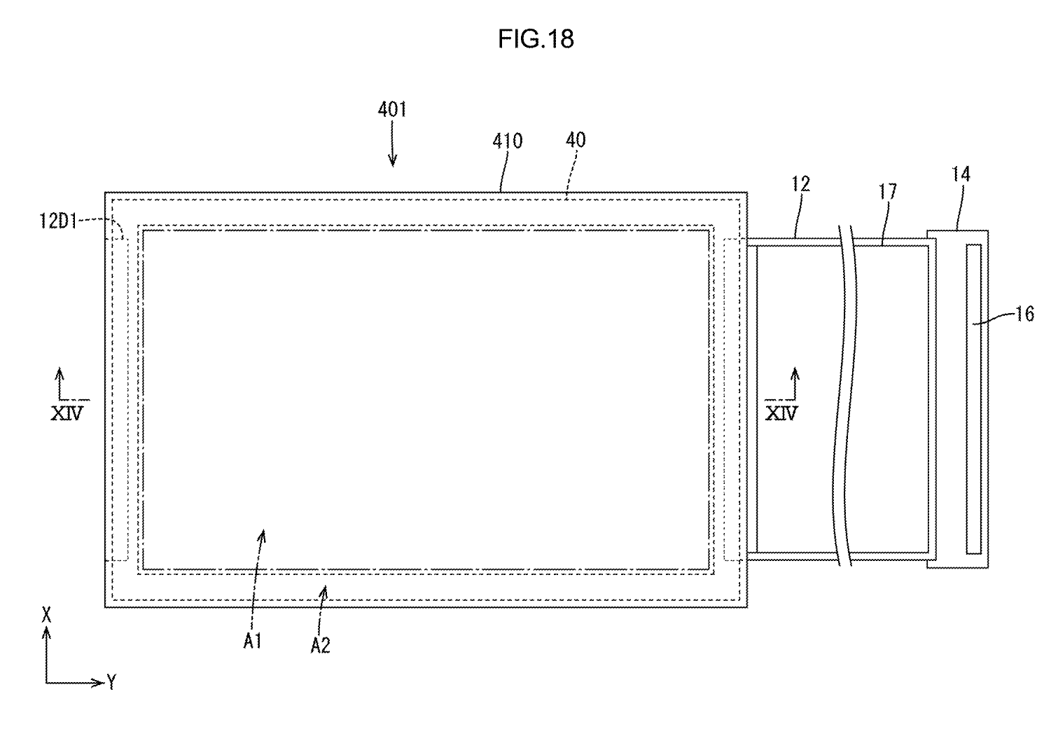

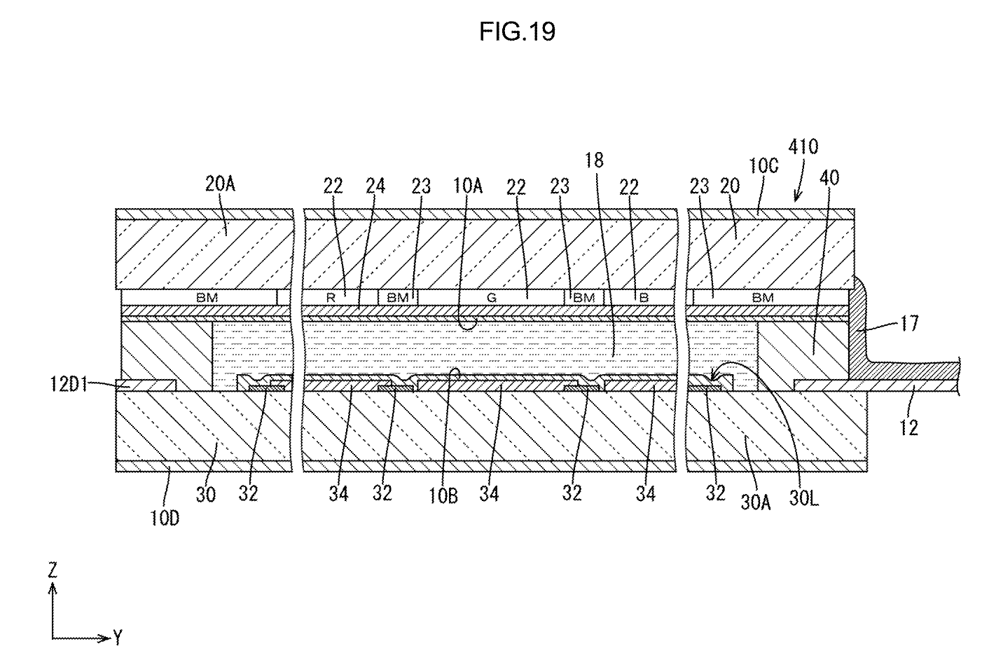

Next, a third embodiment will be described with reference to FIGS. 18 and 19. A liquid crystal display device 401 according to this embodiment includes a first dummy board (an example of a dummy board) 12D1 between the array board 30 and the color filter board 20 in addition to the flexible circuit board 12, which are different from the first embodiment. Other configurations are similar to those of the first embodiment and thus will not be described. As illustrated in FIGS. 18 and 19, in this embodiment, the first dummy board 12D1 is disposed to overlap a section of the sealant 40 in the Z-axis direction and on an edge portion (one side) of a rectangular liquid crystal panel 410 opposite from an edge portion (one side) connected to the flexible circuit board 12. The liquid crystal panel 410 has the display area A1 between the edge portions. Material and a thickness of the first dummy board 12D1 are same as those of the flexible circuit board 12 and the first dummy board 12D1 is formed on the second glass substrate 30A such that an outer surface thereof is aligned with end surfaces of the array board 30a and the color filter 20. The first dummy board 12D1 is not projected outward from the sealant 40. No reinforcing resin film is disposed on the first dummy board 12D1.

If the flexible circuit board is disposed on only one-side section of the liquid crystal panel of a rectangular plan view shape, pressure may not be evenly applied within a panel surface area of the liquid crystal panel in bonding the array board and the color filter board in the process of producing the liquid crystal panel. A distance control between the boards may be difficult. In this embodiment, the first dummy board 12D1 is disposed on the edge portion of the liquid crystal panel 410 that is opposite from the edge portion connected to the flexible circuit board 12 having the display area A1 therebetween. The first dummy board 12D1 is made of the same material and has the same thickness as the flexible circuit board 12. Therefore, the pressure is likely to be applied evenly over a panel surface area of the liquid crystal panel 410 when the array board 30 and the color filter board 20 are bonded to each other in the process of producing the liquid crystal panel 410. The distance between the array board 30 and the color filter board 20 can be substantially constant. This improves display quality of the liquid crystal display device 401.

### Modification of Third Embodiment

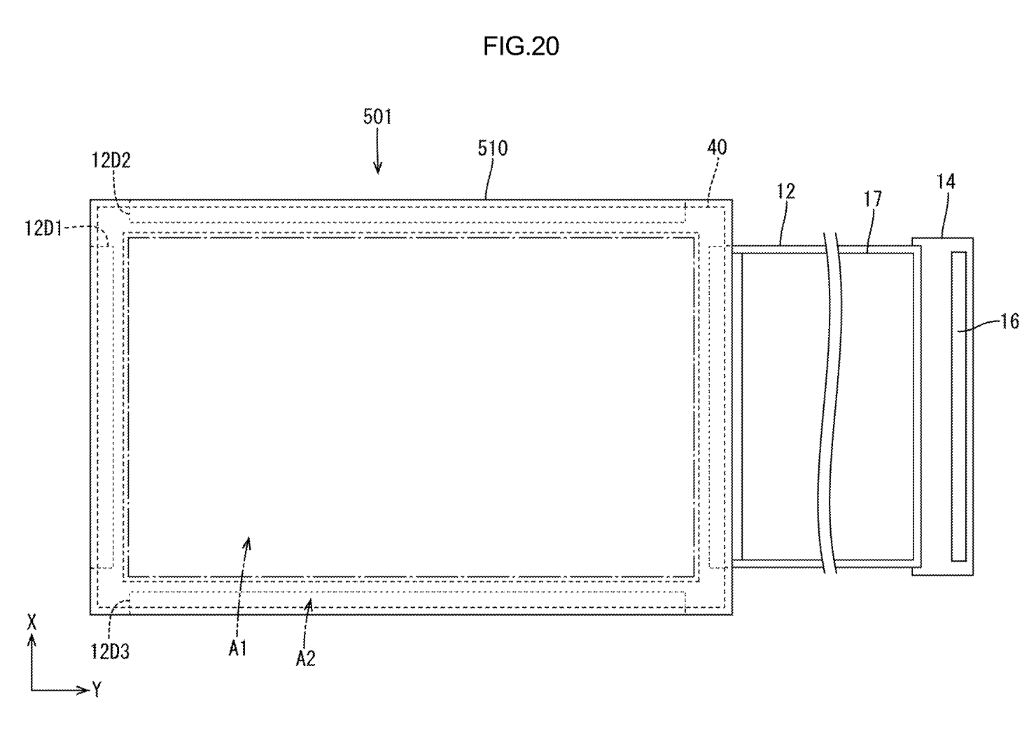

Next, a modification of the third embodiment will be described with reference to FIG. 20. A liquid crystal display device 501 according to this modification includes a second dummy board 12D2 and a third dummy board 12D3 between the array board 30 and the color filter board 20 in addition to the flexible circuit board 12 and the first dummy board 12D1, which are different from the third embodiment. Other configurations are similar to those of the liquid crystal display device 401 according to the third embodiment.

In this modification, as illustrated in FIG. 20, the first dummy board 12D1, the second dummy board 12D2, and the third dummy board 12D3 are disposed on all of the edge portions (other three sides) of the liquid crystal panel 510 except for the edge portion (one side) that is connected to the flexible circuit board 12. The first dummy board 12D1, the second dummy board 12D2, and the third dummy board 12D3 are made of the same material and have the same thickness as the flexible circuit board 12. Therefore, the pressure is likely to be applied evenly over a panel surface area of the liquid crystal panel 510 when the array board 30 and the color filter board 20 are bonded to each other in the process of producing the liquid crystal panel 510. The distance between the array board 30 the color filter board 20 can be substantially constant. Similarly to the third embodiment, no reinforcing resin film is disposed on each of the dummy boards 12D1, 12D2, 12D3 in this modification.

### Fourth Embodiment

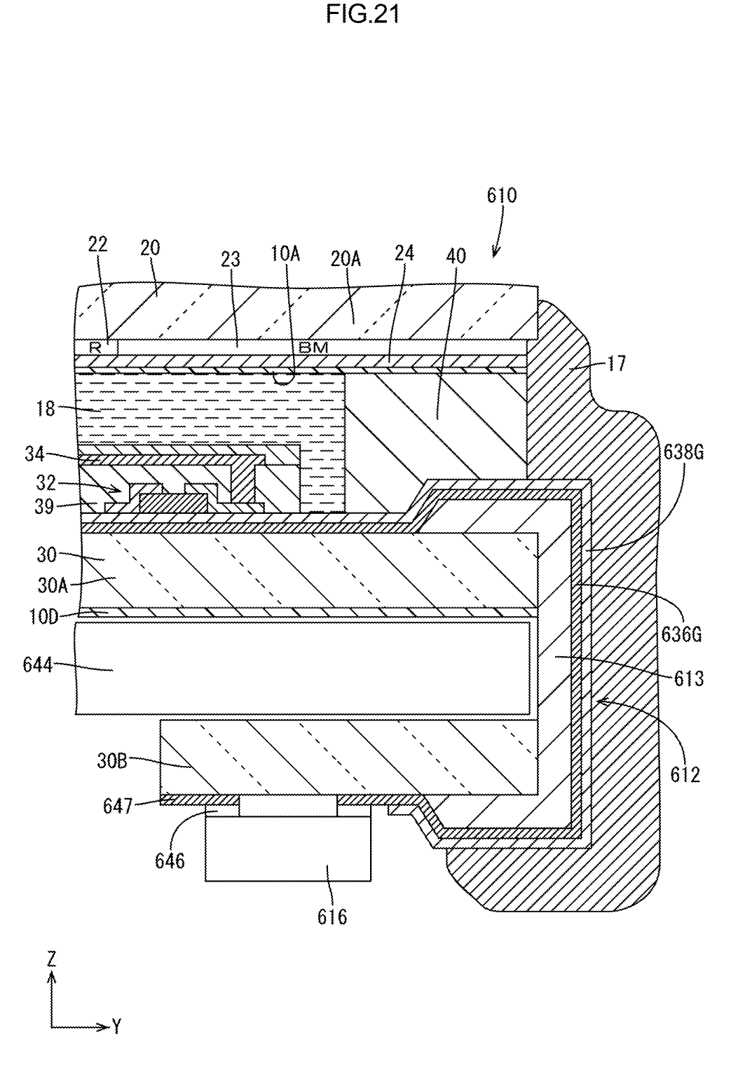

A fourth embodiment will be described with reference to FIGS. 21 to 24. A liquid crystal display device according to this embodiment differs from that of the first embodiment in that an IC chip 616 is mounted on a third glass substrate 30B that is on a rear surface side of a backlight device 644 by the chip-on-glass (COG) mounting method. Other configurations are similar to those of the first embodiment and thus will not be described. In this embodiment, as illustrated in FIG. 21, a flexible circuit board 612 is folded such that a second end (an end opposite from an end that is connected to the array board 30) of the flexible circuit board 612 is disposed on the rear surface side of the backlight device 644. The third glass substrate 30B is connected to the second end. The third glass substrate 30B is a section separated from the second glass substrate 30A by cutting in the production process.

As illustrated in FIG. 21, in this embodiment, the reinforcing resin film 17 is formed over a substantially entire area of a section of a flexible circuit board 612 outside the sealant 40. Pattern lines 647 are formed on the third glass substrate 30B away from the gate lines 636G. A first end of the gate lines 636G disposed on the third glass substrate 30B is not covered with a gate insulation film 638G. The IC chip 16 is mounted on the third glass substrate 30B by the COG mounting method via an anisotropic conductive film 646 to extend from the uncovered section of the gate lines 636G disposed on the third glass substrate 30B to the pattern lines 647. With this configuration, the gate lines 636G and the pattern lines 39B1 are electrically connected to each other. As is not illustrated, a control circuit board may be connected to the pattern lines 30B1 via another flexible circuit board.

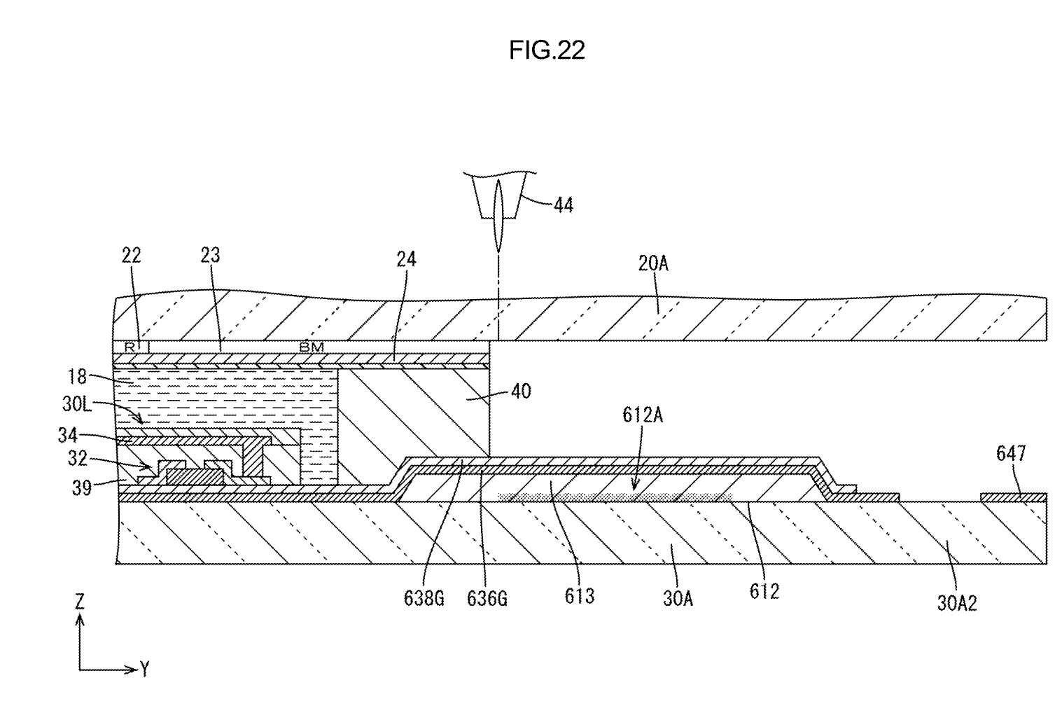

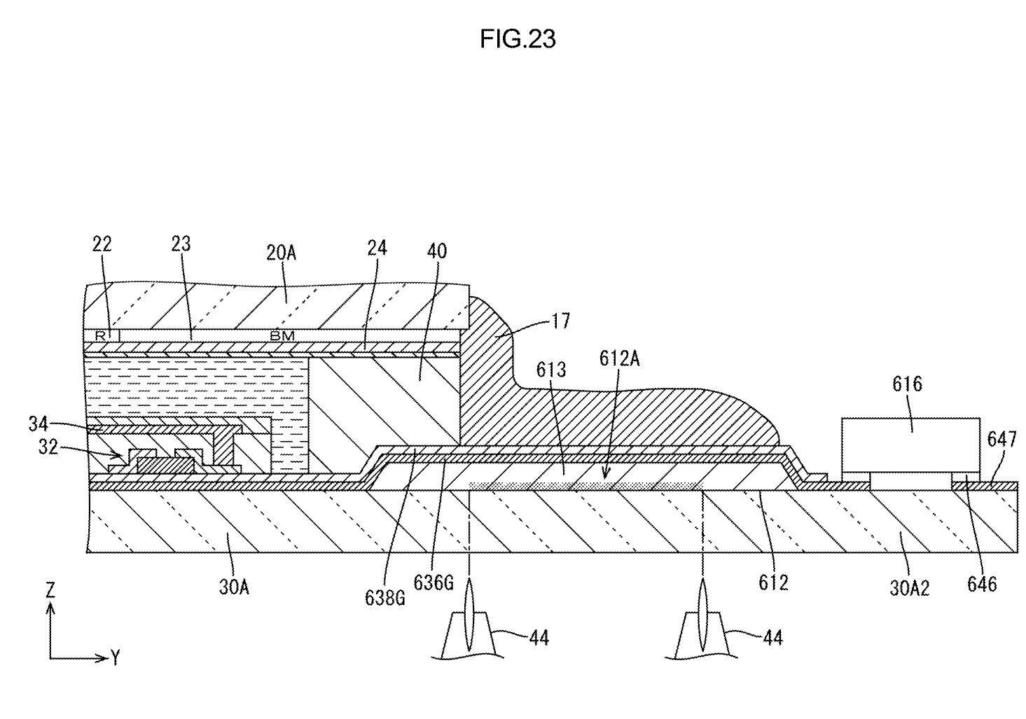

Next, a method of producing a liquid crystal panel 610 having the above configuration will be described. Similarly to the first embodiment, the first resin film forming process, the metal line forming process, the pattern forming process, and the bonding process are performed. As illustrated in FIG. 21, in the first resin forming process, the flexible circuit board 612 is formed on the second glass substrate 30A while keeping an area for mounting the IC chip 616 (a section illustrated with a symbol of 30A2 in FIG. 21) on an opposite side from an area for forming the thin film patterns 30L. The second glass substrate 30A includes the area for mounting the thin pattern films 30L and the area for mounting the IC chip 616 having the flexible circuit board 612 therebetween. In the metal line forming process, the pattern lines 647 are formed near a distal end of the gate lines 636G (on the section 30A2 provided in the first resin film forming process) and opposite and away from the distal end of the gate lines 636G having a predefined space therebetween. The pattern lines 647 are made of the same material as the gate lines 636G. Then, similarly to the first embodiment, the second substrate removing process and the second resin film forming process are performed sequentially (see FIGS. 22 and 23).

Next, the light applying process is performed. As illustrated in FIG. 23, the laser beam L1 is applied to a boundary between a section of the flexible circuit board 612 except for the two end sections and the second glass substrate 30A to form a weak layer 612A at the boundary in this process. The light applying process may be performed before the second substrate removing process. Next, as illustrated in FIG. 23, the IC chip 616 is mounted on the section 30A2 of the second glass substrate 30A provided in the first resin film forming process (a mounting process). In the mounting process, the IC chip 616 is mounted on the section 30A2, on which the flexible circuit board 612 is not formed, by the COG mounting method via the anisotropic conductive film 646 to extend from the gate lines 636G to the pattern lines 647.

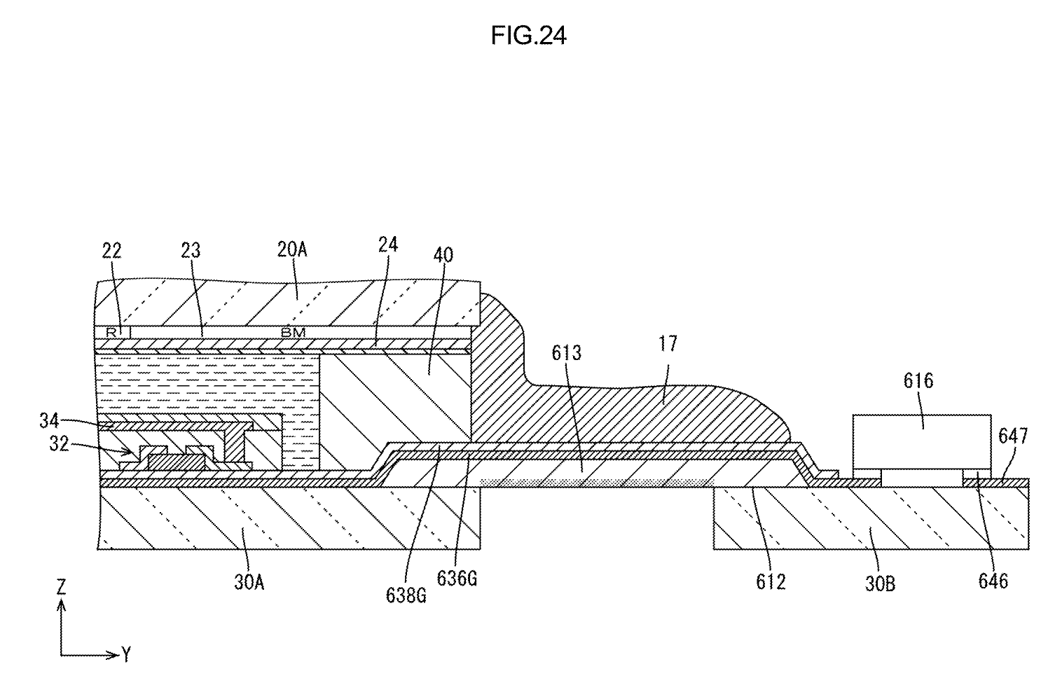

Next, the first substrate removing process is performed. As illustrated in FIG. 23, in this process, the second glass substrate 30A is cut at two boundaries between the section to which the laser beam is applied in the light applying process and other sections. The section of the second glass substrate 30A that is between the two boundaries is separated and removed from the flexible circuit board 612. Accordingly, as illustrated in FIG. 24, the section of the second glass substrate 30A is removed and the second glass substrate 30A includes the section 30A2 where no flexible circuit board 612 is formed. The section 30A2 corresponds to the third glass substrate 30B that is away from the second glass substrate 30A.

Thereafter, the polarizing plates are bonded to the outer surfaces of the glass substrates 20A and 30A and a backlight device 644 is mounted on the rear side of the array board 30, and the control circuit board is connected to the pattern lines 647 on the third glass substrate 30B. Then, the flexible circuit board 612 is warped and folded such that the third glass substrate 30B is on the rear side of the backlight device 644. Through the processes, the liquid crystal panel in this embodiment is complete.

According to the production method of this embodiment as described before, the IC chip 616 is mounted on the section 30A2 provided in the first resin film forming process, and the section except for the section 30A2 having no flexible circuit board 612 is removed from the section of the second glass substrate 30A outside the sealant 40 in the first substrate removing process. Accordingly, after the first substrate removing process, the flexible circuit board 612 positioned between the sealant 40 and the IC chip 616 can be warped and folded. Therefore, the IC chip 616 can be mounted by the COG mounting method on the section outside the sealant 40 and except for the flexible circuit board 612, that is, on the third glass substrate 30B that is away from the second glass substrate 30A without having need for providing the mounting area for the IC chip 616 outside the sealant 40. The liquid crystal display device having a narrower frame can be produced.

In a configuration having a very thin flexible circuit board, if the IC chip is mounted on the flexible circuit board and the section of the second glass substrate directly below the flexible circuit board is removed in the first substrate removing process, the section of the flexible circuit board having the IC chip is not supported by the second glass substrate and may be damaged. However, in this embodiment, the IC chip 616 is mounted on the third glass substrate 30B that is outside the sealant 40. Therefore, the flexible circuit board 612 is less likely to be damaged while achieving a configuration of the very thin flexible circuit board 612 (for example, 2 μm).

### Fifth Embodiment

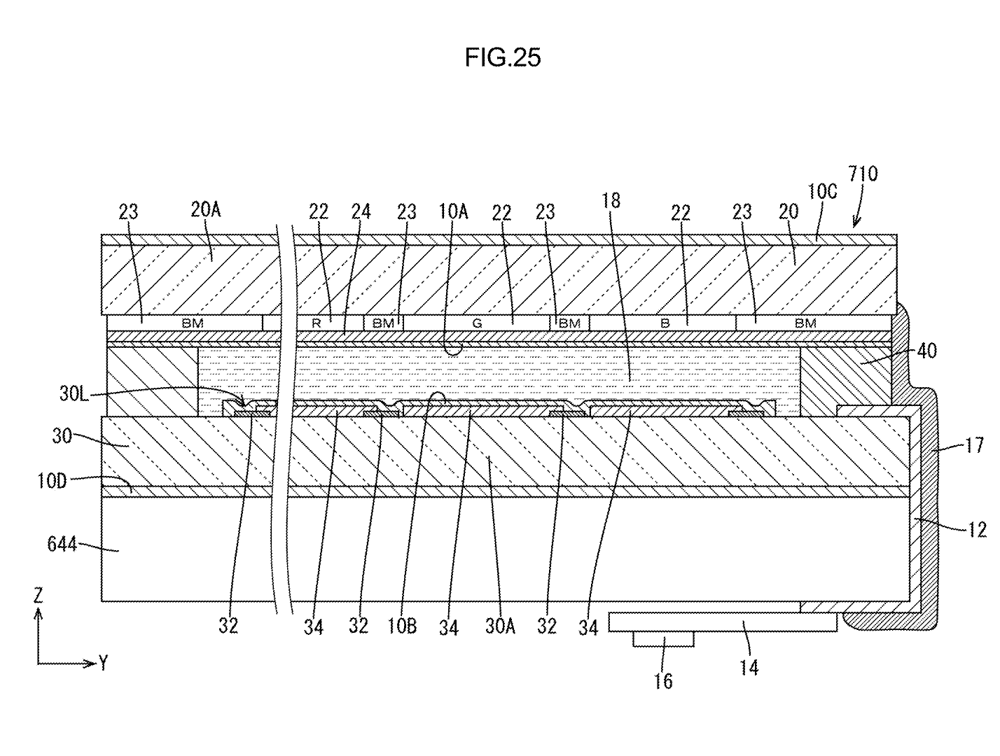

Next, a fifth embodiment will be described with reference to FIG. 25. As illustrated in FIG. 25, a liquid crystal display device according to this embodiment includes a backlight device (an example of the lighting device) 644 that is fixed on a rear side of the array board 30 of a liquid crystal panel 710 . A section of the flexible circuit board 12 except for the section between the array board 30 and the color filter board 20 is fixed to the backlight device 644. Other configurations are similar to the first embodiment.

In this embodiment, with the above configuration, the liquid crystal display device can be thinner compared to a configuration that the liquid crystal panel or the flexible circuit board is away from the backlight device. If the liquid crystal panel or the flexible circuit board is away from the backlight device, the flexible circuit board may be warped and damaged when the flexible circuit board is mounted on the frame of the liquid crystal display device during the production process of the liquid crystal display device. However, in this embodiment having the above configuration, the flexible circuit board 12 is less likely to be damaged during the production process of the liquid crystal display device.

Modifications of each of the above embodiments will be described below.

(1) In each of the above embodiments, the section of the flexible circuit board that is between the array board and the color filter board overlaps only the non-display area of the liquid crystal panel in the Z-axis direction. However, the section of the flexible circuit board that is between the array board and the color filter board may overlap the display area of the liquid crystal panel. With such a configuration, if the flexible circuit board is formed of a transparent material having transmissivity, a display failure or deterioration of display quality is less likely to occur.

(2) In each of the above embodiments, the flexible circuit board is made of resin material of polyimide that is opaque. However, the material of the flexible circuit board is not limited thereto. Polyimide is preferably used in view of heat resistance properties. If the thin film patterns are formed prior to the forming of the flexible circuit board, transparent polyimide or resin material other than polyimide may be used for forming the flexible board and the flexible circuit board is less likely to be adversely affected in the pattern forming process.

(3) In each of the above embodiments, the IC chip is mounted on the glass substrate or the control circuit board. However, the mounting position of the IC chip is not limited thereto. For example, the IC chip may be mounted on the flexible circuit board supported by the glass substrate or the IC chip may not be mounted on the glass substrate or the flexible circuit board even though the glass substrate is disposed outside the sealant.

(4) In each of the above embodiments, the liquid crystal panel has a rectangular plan view shape. However, a liquid crystal panel having an outline a part of which is curved may be included in a scope of the present invention.

(5) In each of the above embodiments, the liquid crystals are injected into a section surrounded by the sealant by the one drop fill (ODF) method using the liquid crystal dropping device to form the liquid crystal layer between the substrates. However, it is not limited thereto and the liquid crystals may be injected into a section between the substrates after the bonding process.

(6) In each of the above embodiments, the laser beam is applied to the boundary between the second glass substrate and the flexible circuit board in the light applying process. However, light applied in the light applying process is not limited to the laser beam. For example, light from a flash lamp that is other light than the laser beam may be applied to the boundary in the light applying process such that the weak layer may be formed in the portion of the flexible circuit board at the boundary by light energy of the light from the flash lamp.

(7) In each of the above embodiments, acrylic resin or silicon resin is used as the resin for the second resin film. However, the resin for the second resin film is not limited thereto. In each of the above embodiments, the second resin film is formed by applying and curing solution resin. However, a method of forming the second resin film is not limited thereto. For example, the second resin film may be formed by bonding a resin film on the glass substrate with adhesive.

(8) In the fourth embodiment, the mounting process is performed before the first substrate removing process. However, the mounting process may be performed after the first substrate removing process.

(9) In each of the above embodiments, a driving type of the liquid crystal panel is a twisted nematic (TN) type. However, it is not limited thereto and a driving type of the liquid crystal panel may be an in-plane switching (IPS) type, a multi-domain vertical alignment (MVA) type, or a fringe field switching (FFS) type.

(10) In each of the above embodiments, the liquid crystal display device and the method producing thereof are described. However, it is not limited thereto and display devices other than a liquid crystal display device may be included in a scope of the present invention. For example, a method of producing an organic EL display device may be included in a scope of the present invention.

The embodiments of the present invention are described in detail. However, the present invention is not limited to the embodiments. Modifications or altered modes of the embodiments described above are also included in the technical scope of the present invention.

### EXPLANATION OF SYMBOLS

1, 401, 501: Liquid crystal display device, 10, 110A, 110B, 210, 310, 410, 710: Liquid crystal panel, 12, 212, 612: Flexible circuit board, 12D1: First dummy board, 12D2: Second dummy board, 12D3: Third dummy board, 13: polyimide film, 14: Control circuit board, 16, 616: IC chip, 17: Reinforcing resin film, 18: Liquid crystal layer, 20: Color filter board, 20A: First glass substrate, 24: Counter electrode, 30, 130, 230: Array board, 30A, 130A, 230A, 330A: Second glass substrate, 30B: Third glass substrate, 30B1: pattern lines, 30L, 230L: Thin film patterns, 32: TFT, 32D: Drain electrodes, 32G: Gate electrodes, 32S: Source electrodes, 34: Pixel electrodes, 36G, 636G: Gate lines, 37: Semiconductor film, 38G, 238G, 338G, 638G: Gate insulator film, 40: Sealant, 44: Scriber, 236G1, 336G1: First gate lines, 236G2, 336G2: Second gate lines, 238G1: First gate insulator film, 238G2: Second gate insulator film, 646: Anisotropic conductive film, A1: Display area, A2: Non-display area, CH1, CH2: contact hole

1. A method of producing a display device comprising:
a first resin film forming process of forming a first resin film having flexibility on one section of a first substrate;
a metal line forming process of forming metal lines continuously on another section of the first substrate and on the first resin film and forming an insulator film on the metal lines;
a pattern forming process of forming thin film patterns on the other section of the first substrate;
a bonding process of disposing sealant on the first substrate to surround the thin film patterns and bonding the first substrate and a second substrate opposite each other with the sealant after the resin film forming process, the metal line forming process, and the pattern forming process;
a second substrate removing process of removing a section of the second substrate outside the sealant after the bonding process;
a second resin film forming process of forming a second resin film on the first resin film outside the sealant after the second substrate removing process; and
a first substrate removing process of separating and removing at least a section of the first substrate outside the sealant from the first resin film after the bonding process.

2. The method of producing a display device according to claim 1, wherein
in the first resin film forming process, the first resin film, the metal lines, and the insulator film are formed such that a total of thicknesses of the first resin film, the metal lines, and the insulator film is smaller than a distance between the first substrate and the second substrate that are bonded opposite each other in the bonding process, and
in the second resin film forming process, the second resin film is formed to have a thickness greater than a total of thicknesses of the first resin film, the metal lines, and the insulator film.

3. The method of producing a display device according to claim 2, wherein
in the first resin film forming process and the metal line forming process, the first resin film, the metal lines, and the insulator film are formed such that a total of thicknesses of the first resin film, the metal lines, and the insulator film is smaller than a thickness of the thin film patterns formed in the pattern forming process.

4. The method of producing a display device according to claim 1, further comprising a light applying process of applying light on a boundary between the section of the first substrate that is to be removed in the first substrate removing process and the resin film before the first substrate removing process.

5. The method of producing a display device according to claim 1, wherein in the first resin forming process, the first resin film that is mainly made of polyimide is used.

6. The method of producing a display device according to claim 1, wherein
in the first resin film forming process, the first resin film is formed on the first substrate while providing an area for mounting a driver component for driving the display device on an opposite side from an area for forming the thin film patterns with sandwiching the first resin film therebetween,
in the first substrate removing process, at least a part of a section of the first substrate except for the area that is provided in the first resin film forming process is removed, and
the method further comprises a mounting process of mounting the driver component on the area on the first substrate provided in the first resin film forming process after the second substrate removing process.

7. The method of producing a display device according to claim 1, wherein in the first resin film forming process, the first resin film including a metal film is formed near a boundary with the first substrate.

8. A display device comprising:
a display panel including substrates in a pair that are bonded with sealant, the display panel performing displaying;
a flexible circuit board having flexibility and including thereon metal lines through which signals for driving the display panel are transmitted and an insulator film covering the metal lines, the flexible circuit board having a first end that is connected to one of the substrates and having a section that is between the substrates and overlaps the sealant in a thickness direction of the substrates, and the flexible circuit board being formed of a first resin film; and
a reinforcing resin film for reinforcing the flexible circuit board, the reinforcing resin film being formed of a second resin film and disposed on the first resin film and outside the substrates and having a thickness greater than that of the first resin film.

9. The display device according to claim 8, wherein
one of the substrates includes thin film patterns thereon,
the sealant is disposed to surround the thin film patterns, and
the metal lines are formed of a single metal film and a section of the metal lines forms a section of the thin film patterns and the metal lines extends continuously from the thin film patterns to outside of the sealant.

10. The display device according to one of claim 8, wherein
the display panel includes a display area and a non-display area within a panel surface area, the display area displaying images and the non-display area displaying no images, and
the flexible circuit hoard is disposed such that the section thereof between the substrates is disposed only in a position overlapping the non-display area in the thickness direction of the substrates.

11. The display device according to claim 8, wherein
the display panel has a rectangular shape in a plan view, and
the flexible circuit board is disposed on one side of the display panel and a dummy board is disposed on at least one of other sides of the display panel such that a part of the dummy board is between the substrates and overlaps the sealant in the thickness direction of the substrates, and the dummy board is made of material same as the flexible circuit board and has a thickness same as the flexible circuit board.

12. The display device according to claim 8, further comprising a lighting device supplying light to the display panel, wherein
the flexible circuit board has a part other than the section disposed between the substrates and the part is fixed to the lighting device.
